(19) United States
(12) Patent Application Publication
(10) Pub. No.: US 2025/0335528 A1
(43) Pub. Date: Oct. 30, 2025

(54) CONTEXTUAL DELIVERY OF ACCESS TO ARTIFICIAL INTELLIGENCE FUNCTIONALITY

(71) Applicant: MicroStrategy Incorporated, Vienna, VA (US)

(72) Inventors: Ajitpal Singh Raina, Herndon, VA (US); Vyom Sharma, Delhi (IN); Gregorio Parra, Vienna, VA (US); Azizbek Tashpulatov, Mount Rainier, MD (US); Tejas Sahasranaman, Fairfax, VA (US); Jose Nocedal, Leesburg, VA (US); Saurabh Abhyankar, McLean, VA (US); Jeffrey Clay Courcelle, Atkinson, NH (US)

(21) Appl. No.: 19/192,253

(22) Filed: Apr. 28, 2025

Related U.S. Application Data
(60) Provisional application No. 63/640,130, filed on Apr. 29, 2024.

(51) Int. Cl. G06F 16/9538; G06F 21/60

(52) U.S. Cl. CPC G06F 16/9538; G06F 21/604

(57) ABSTRACT

Methods, systems, and apparatus, including computer-readable media, for contextual delivery of access to artificial intelligence functionality. In some implementations, a system provides data for an information card corresponding to an entity, where the information card includes (i) content including one or more attributes or measures for the entity and (ii) one or more elements for accessing a chatbot. After user interaction with the one or more elements provided by the information card, the system receives a user prompt from the user entered through a chatbot interface that is provided on the information card or is presented in response to the user interaction with the one or more elements. The system provides a chatbot response to the user prompt for presentation in the chatbot interface, wherein the chatbot response is generated based on the content of the information card.

### CROSS-REFERENCE TO RELATED APPLICATIONS

This application claims the benefit of priority to U.S. Application No. 63/640,130, filed on Apr. 29, 2024, the contents of which are hereby incorporated by reference.

### FIELD OF THE INVENTION

The present specification relates to contextual delivery of database content and access to artificial intelligence functionality, such as artificial intelligence chatbots.

### BACKGROUND

The amount of data generated and stored in enterprise systems continues to increase. The ability to access information relevant to a topic or task quickly is important for people to work effectively in a wide range of fields.

Artificial intelligence (AI) and machine learning (ML) techniques have improved significantly and continue to gain new capabilities. For example, neural network models, such as large language models, have shown the capability to process and to generate many types of natural language text. For example, chatbots that leverage large language models can respond to user prompts (e.g., user inputs such as questions) in text-based messaging sessions or conversations with users. Training the most capable models typically requires a very large amount of training data as well as large amounts of computing power and time. Many users use generalized models that are highly trained and highly capable, but are limited to default behavior and cannot be customized for particular uses or contexts.

### SUMMARY

In some implementations, a computer system provides functionality to provide contextually-driven information from private data sets (and/or public data sets) as well as access to artificial intelligence or machine learning chatbots that can provide answers about the data sets. The system can combine information from a predefined set of data types, such as a set of metrics and attributes or key indicators, with a chatbot interface that provides more dynamic and expensive access to the underlying data set. The system can associate specific chat bots with specific card definitions or card templates, so that information cards respectively provide access to the appropriate chatbot that is most relevant to the information card and its associated data set. In addition, the system can associate specific card definitions with specific chatbots To cause information card content to be made accessible through other chatbot interfaces, including through standalone applications, web pages, software extensions or add-on modules, and so on.

For example, a system can specify in advance that keywords in certain categories or groups, when identified in a user interface, can be annotated and made interactive to trigger display of an information card overlay. The information card can be configured to display specific types of statistics or indicator values that are relevant to the type of entity represented by the keyword, and the information card is populated with values obtained from a data set (e.g., private database content) for the particular entity referenced. For example, a system can have a card defined for entities of type company, with a number of specific indicators specified (e.g., phone number, address, revenue, CEO name, etc.). When a company name is identified in user interface content, a user can interact with the company name to trigger display of an information card that provides the indicator values for the particular company named, with the indicator values being generated from the current data in the data set.

In addition, the information card can include controls or regions to interact with an AI/ML chatbot to enable the user to request and receive information beyond what was defined for the content of the information card. For example the information card itself can include a text entry field that accepts questions or other user prompts for a chatbot that has access to the same underlying data set used to populate the other values shown in the information card. As a result, the information card provides both (1) a standardized set of important information that can be consistent across information cards of the same entity type, and (2) chatbot access features that enable the user to access a much broader set of information from the associated data set. As a result the information card is not purely static in the content that is available. A pop up information card provides immediate useful information as well as gives the user confidence that the user can gain access to other data in the underlying data set, including further filtering or drilling down to obtain additional information related to the statistics or values shown in the information card and in many cases other types of information about the subject entity that are not initially listed in the information card. The information card provides a seamless the process for invoking the interface, the act of which set the applicable data set and entity referenced by the data set for any further questions to the chatbot.

This provides a number of advantages to the user, including the familiarity of consistent, important information for each entity type, as well as an immediate window to an extensive set of data that is not predefined for the user. As another example, the information card provides a low latency interface that is very efficient in conserving limited screen space, which is important in many contexts and especially on mobile devices.

In some implementations, the chatbot interface provided in or with an information card can be tailored for the information context of the information card. For example, the information card may relate to a particular entity, such as a specific company, person, location, product, etcetera. The identity of the entity, as well as the key values shown in the information card representing current information from the database as well as what the user is currently viewing, can be provided to the chatbot along with any user prompts that the user enters. As a result, the chatbot can effectively interpret user prompts received through the chatbot interface in the relevant context of the entity and its data in the information card. This can greatly streamline the chat process and improve the effectiveness of communication with the chatbot. For example, even if a user's question does not specify the entity related to the information card, that information is still automatically provided to the shop bot along with each user prompt. As a result, the chatbot knows which entity the user is viewing information about and about which the question is being asked.

In some implementations, the information card is triggered or invoked from another interface, such as a web page or document. The system can gather and provide the content surrounding the keyword from which the information card was invoked to provide additional context to the chatbot. For example, if the user is viewing a web page and the information card display is triggered from a keyword in that web page, the context provided to the chatbot can include the entity and keyword identified, the information card content presented in the information card, as well as the content of the web page or document in which the keyword was found.

The chatbot interface can be integrated with a dynamic content area such as a information card overlay in various ways. For example, the information card region can directly include a text input field to receive a user prompt to the chatbot. As another example, the chatbot interface may be initially hidden, but an icon or button can be included to initiate display of the chatbot interface. In some implementations, the chatbot interface is shown in the same area or frame as the information card, EG, within the boundaries or borders of the information card itself. In some cases, the chatbot interface is initially shown in a small region of the information card, but interaction with the chatbot causes the chatbot interface region to expand, potentially replacing or covering some or all of the other information card content. This version it can be especially helpful when screen space is limited. The user can interact with controls of the information card to switch or toggle between the majority of the information card region being filled with predetermined content or chatbot content. As another example, interaction with the chatbot functionality or a corresponding control can cause a related panel or region to be displayed, such as directly to the side of the information card (e.g., in an adjacent card or in an expanded region of the information card). This can be advantageous so that the user can view the information card content while also forming prompts to the chatbot or reviewing chatbot answers.

The chatbot interface in or associated with an information card can also provide suggested prompts or queries for the user to submit to the chatbot. The initial set of suggested prompts can be predetermined queries specified by the creator of the chatbot, or can be recent or frequent queries that have been submitted (e.g., for the current chatbot or its associated data set, for the current category of entity or information card, etc.). In addition, the system can be configured to refresh or generate more focused suggested queries based on interactions of the user with the information card. For example, if the user selects or taps a particular type of metric or attribute, such as “revenue,” the system can automatically provide one or more suggested queries specifically related to the revenue metric. In this manner, in response to the user interacting with different portions of the information card, the system can update the chatbot interface to show different suggested queries to the chatbot that are respectively customized or focused on the topic or data of the information card region that the user interacted with.

The computer system can also provide features that facilitate the process for administrators to enable the chatbot access through information cards. For example, the system can provide an interface for administrators where an administrator can link a chatbot to a particular card type. The system saves data indicating this link, so that information cards based on a particular card definition or card template will interact with the particular chatbot that the administrator associated with the card definition or card template. In this process, the system can automatically identify which chatbots that are available in an environment have access to the data set used to generate information cards from a particular card definition or card template. For example, when a card template is configured to pull data from a particular data set, the system can identify the subset of chatbots that have access to that particular data set and suggest or propose that subset of chatbots as candidates to interface with through the information card.

The system can provide administrators with other capabilities in customizing the behavior of a chatbot when it is provided through an information card. For example, the system can provide administrators a setting that specifies the scope of accessible data within the information card chatbot interface. For example, the administrator can set the scope of chatbot conversations to be limited to data about the particular entity referenced in the information card. In this case, if the limit is set, and the information card corresponds to a particular company, the system can limit the chatbot to accessing only data about the particular company when answering questions provided through the chatbot interface of the information card. The system can cause this limitation to be enforced in various ways, such as by providing a custom instruction to the chatbot that limits the scope of responses and/or enforcing a filter or other restriction on data retrieval from the underlying data set, so that only the subset of data corresponding to the particular entity is provided to the chatbot for formulating responses. As an alternative, the administrator may use the setting to allow a wider scope for chatbot conversations, including conversations about any of the data in the data set from which the information in the information card was taken, and not just for information about the particular entity or topic of the information card. The system can also provide administrators a setting to specify which additional data sources, if any, can be used by the chatbot in answering questions period for example, the administrator may specify or white list specific documents, data sets, Internet domains, or other data sources that can supplement the main data source when the chatbot generates responses to user prompts.

In some implementations, the system is configured to enable the presentation of information cards through chatbot interfaces. This ability to access information cards through a chatbot interface can be provided for various types of chatbot interfaces, whether as a standalone app application, as a web page, as an extension module or add-on component, etcetera. For example, a server system can store information about the information cards available in an organization and the corresponding keywords that relate to those information cards. When a user enters a prompt, or when a chatbot response is received to be provided to the chatbot interface, the server can examine the user prompt and slash or chatbot response to detect the presence of keywords having corresponding information cards. When the system detects one of the keywords, the system can retrieve the information card content for the associated information card. The server system can then transmit chatbot responses with embedded information card data that allows the client device to display annotations of the keyword in the chatbot response as well as display the information card. As a result, chatbot responses that contain appropriate keywords can be provided with metadata or markup content that designates the keywords as providing information cards. The information card content itself is also embedded in, or pushed to, the user device with the chatbot response so it can be available for presentation without incurring any retrieval or network latency.

These techniques can also provide the advantage of making information cards available through devices that do not have a installed extension module or add-on component. Because the detection of keywords, markup of those keywords, and embedding of information card content is done at the server, the data package for display can already include the code or functionality enabling information cards to be presented by the user device that receives the data package. For example, a chatbot response can include markup language content, Javascript code, metadata, or other content so that when the chatbot response is rendered and displayed, the interactivity on the relevant keywords is provided. In this process, the chatbot creator can have control to specify which types of information cards can be presented, such as by specifying the entity types that will trigger information cards we're specifying a specific list of card definitions or card templates to be used.

As discussed further below, the system can empower information card authors to link AI/ML chatbots to their cards. This integration will allow users to pose additional questions and gain deeper insights from an AI/ML chatbot that can power answers from a wider data set than simply what is visible on the face of the card, and can access deeper levels of analysis to provide automated insights, all within the context of the user's journey in their web application and the data point they are analyzing through the card. Hyper card authors can configure the entry point to an AI/ML chatbot from an information card. As they do this, they can browse standalone chatbot objects and select the one to be associated with the card definition they are editing.

In some implementations, the behavior of the information card changes when the chatbot interface portion is used. For example, The information card can become “sticky” when the user starts interacting with its chatbot. This is to avoid the user unintentionally dismissing the card when they move the mouse away or click outside of the card, which would also lose the chat conversation. Users can instead be required to dismiss the card by clicking a ‘close’ button to ensure intentional action when ending the conversation.

In one general aspect, a method performed by one or more computers includes: providing, by the one or more computers, data for an information card corresponding to an entity, wherein the information card includes (i) content including one or more attributes or measures for the entity and (ii) one or more elements for accessing a chatbot configured to provide responses generated using one or more artificial intelligence and/or machine learning (AI/ML) models; after user interaction with the one or more elements provided by the information card, receiving, by the one or more computers, a user prompt from the user entered through a chatbot interface that is provided on the information card or is presented in response to the user interaction with the one or more elements; and providing, by the one or more computers, a chatbot response to the user prompt for presentation in the chatbot interface, wherein the chatbot response is generated based on the content of the information card.

In some implementations, the information card is based on a card template corresponding to an entity type, and the card template is associated with a particular chatbot from among multiple chatbots; and the one or more elements provide access to the particular chatbot.

In some implementations, the one or more computers are configured to provide chatbot responses from each of multiple chatbots, wherein at least some of the multiple chatbots are configured to provide responses based on different data sets. The method includes storing multiple card templates, where: each card template corresponds to an entity type, the one or more computers are configured to use each card template to generate information cards for each of multiple entities of the corresponding entity type, and each of the multiple card templates specifies a chatbot, from among the multiple chatbots, to be used to respond to user prompts. The one or more computers are configured to select, in response to a user prompt associated with a particular information card, to use the chatbot that is specified in the card template used to generate the particular information card for generating a chatbot response.

In some implementations, the one or more AI/ML models comprise a large language model (LLM).

In some implementations, the LLM has a context window; and the method includes providing the content of the information card to the LLM so the content of the information card is included in a context window of the LLM when the LLM is used to generate the chatbot response.

In some implementations, the information card is displayed at a user device in response to interaction of the user with a user interface, and wherein the chatbot response is generated based on content of the information card.

In some implementations, the method includes providing the content of the user interface to the one or more AI/ML models so the content of the information card is included in a context window of the one or more AI/ML models when the one or more AI/ML models are used to generate the chatbot response.

In some implementations, the one or more elements comprise a text entry field configured to receive a user prompt to the chatbot.

In some implementations, the one or more elements comprise an interactive element configured to respond to user interaction to cause a chatbot interface to be provided in the information card or adjacent to the information card.

In some implementations, the one or more elements are configured to cause, upon user interaction, presentation of a chatbot interface; and the one or more computers are configured to provide, for display in the chatbot interface, one or more suggested prompts that are based on the content of the information card.

In some implementations, the method includes generating the suggested prompts based on data that identifies the entity, such that one or more of the suggested prompts includes a reference to the entity.

In some implementations, the one or more of the suggested prompts are displayed before the user enters a prompt in the chatbot interface, and wherein at least one of the suggested prompts is generated to include a reference to the entity based on the information card corresponding to the entity.

In another general aspect, a method performed by one or more computers includes receiving, by the one or more computers, a user prompt provided through a chatbot interface for a chatbot configured to provide responses generated using one or more artificial intelligence and/or machine learning (AI/ML) models; generating, by the one more computers, a chatbot response to the user prompt using the one or more AI/ML models; analyzing, by the one or more computers, the chatbot response to identify a reference to an entity in the chatbot response; in response to identifying the reference to the entity in the chatbot response, obtaining data for an information card corresponding to the entity, wherein the information card includes one or more attributes or measures for the entity obtained from a database; providing, by the one or more computers, the chatbot response for display, wherein the chatbot response is provided with (i) annotation data configured to cause the reference to the entity to be visual distinguished from other text of the chatbot response and (ii) the data for the information card, such that when the chatbot response is displayed user interaction with the reference to the entity in the chatbot response causes presentation of the information card for the entity.

In some implementations, receiving the user prompt comprises receiving the user prompt at a server system over a communication network from a client device; and providing the chatbot response comprises providing the chatbot response from the server system to the client device over the communication network.

In some implementations, providing the chatbot response for display comprises providing a data package that includes the chatbot response, the annotation data, and the data for the information card, wherein the data for the information card is provided before the user interacts with the reference to the entity in the chatbot response, such that the data for the information card is already present at the client device before the user interacts with the reference to the entity in the chatbot response.

In some implementations, the annotation data comprises markup language content, formatting parameters, or data to define a visual overlay.

In some implementations, the method includes storing entity data that associates terms with entities; analyzing the chatbot response comprises analyzing the chatbot response to identify instances of the terms in the entity data in the chatbot response; and obtaining the data for the information card corresponding to the entity is based on identifying a particular term in the chatbot response that the stored entity data indicates ins associated with the entity.

In some implementations, the chatbot is associated with one or more card templates, and each of the card templates corresponds to a different entity type; and the one or more computers are configured to analyze chatbot responses to detect references to entities of the entity types for the one or more card templates that the chatbot is associated with.

In some implementations, the chatbot is configured to provide responses based on data from one or more data sets; and the one or more computers are configured to analyze chatbot responses to detect references to entities of the entity types corresponding to one or more card templates that specify to use information from the one or more data sets corresponding to the chatbot.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram of an example of a system for contextual delivery of database content and interfaces for AI/ML chatbots.

FIGS. 2A-2B are diagrams illustrating another example of a system for contextual delivery of database content and interfaces for AI/ML chatbots.

FIG. 3A is a diagram illustrating an example of an information card that includes an interface for an AI/ML chatbot.

FIG. 3B is a diagram illustrating an example of a user interface showing an information card provided in response to user interaction.

FIGS. 4A-4C are diagrams that illustrate examples of user interfaces for accessing AI/ML functionality.

FIG. 5 is a diagram that illustrates an example of a user interface that process access to information cards and AI/ML functionality.

FIGS. 6A and 6B are diagrams showing an example of a system for creating, distributing, and using customized AI/ML chatbots.

FIG. 7 is a diagram showing a user interface showing an example of information cards being accessible from or being embedded in content of an AI/ML chatbot.

FIG. 8A-8C are diagrams showing example user interfaces that that show functionality to connect information cards and AI/ML chatbots.

FIG. 9 is a diagram that shows an example of a user interface for configuring an AI/ML chatbot user interface, including associating information cards with an AI/ML chatbot.

FIGS. 10A-10C are diagrams showing example user interfaces for accessing AI/ML functionality.

Like reference numbers and designations in the various drawings indicate like elements.

### DETAILED DESCRIPTION

In some implementations, a computing system can identify keywords in a user interface and dynamically retrieve and present relevant information inline with the user interface. For example, a client device can run a software agent, such as a web browser extension, that monitors a user interface for instances of certain keywords. When the keywords are present, the software agent annotates the keywords and makes them interactive in the user interface. If a user interacts with a keyword, for example, by placing a cursor over the keyword, the software agent causes an information card or information panel to be displayed, e.g., overlaying a portion of the original user interface or otherwise inserted into the user interface. The information card can include a chatbot interface, such as a region with a text input field to receive user prompts or a button or other control to present or reveal chatbot interface. In this manner, the user can easily access information that is contextually relevant to the user interface, without the need to open a new application or switch between interfaces. This technique also provides numerous other advantages, discussed below, such as allowing content to be efficiently integrated with third-party user interfaces that the content provider does not control.

The system allows for significant customizability. These keywords monitored by the software agent can be specific to a user or the user's organization. For example, when the user is an employee of a company, the keywords of interest can be extracted from a private data set or database for the company. The keywords can additionally or alternatively be selected or filtered to terms applicable to the specific user, e.g., terms relevant to the user's role in the company. When one of the keywords is determined to be present in the user interface, the software agent communicates with a server system to obtain information related to the keyword. This information can include data retrieved from a private database that has information specific to an organization associated with the user. For example, if the keyword refers to a customer of a user's company, status information, statistics, contact information, and other information about the customer's account with the company can be provided from the company's private database.

The type of information provided, as well as the values shown for those information types, can be customized for the user and organization. For example, a sales representative and a product engineer at the same company may be shown different types of information for the same keyword, due to their different roles. Similarly, two users in a company with the same role might be shown different information for the same keyword, due to the users having different types of previous interactions with the system. In general, the system can use machine learning techniques to predictively select which information to show to a particular user at a particular time for a given keyword, and how to organize the information.

In many conventional systems, user interfaces have a predetermined structure or layout designed to accommodate the content displayed. To add a new frame or region of the interface, the structure of each user interface to be updated usually must be changed one by one. For example, to provide embedded content in a web page or web application, the user interface is often designed to include an iFrame or other element for the embedded content. Native applications also generally have predefined user interface layouts. This often makes it difficult to add or alter embedded content regions in user interfaces because the source code, HTML code, or other data defining each user interface needs to be individually changed. For example, it may be desirable to provide a new embedded content region in each of many different pages of a web site or web application, but doing so may require changes to each of the pages individually.

Embedding content is also challenging because the party desiring to embed the content may not control or have the ability to change the underlying user interface. For example, one company may have content to be embedded in an application provided by a different company. The content provider would need to rely on the application provider to modify the structure of the application, one page at a time, in order to have the content embedded. For example, it is often difficult for a company to integrate content from its proprietary database into a user interface provided by a third party, e.g., an e-mail application, a word processing application, a spreadsheet application, etc., because the company generally cannot change the structure of the user interface provided by the third-party.

The challenge of embedding content in user interfaces is also significant since the embedded content may be needed only selectively. For example, it may be desirable to embed content on some pages but not others. Similarly, the embedded content may only be applicable for a page at certain times and not others. The need for the embedded content may vary over time, and may be dependent on factors such as the context provided by other content in the page, which may also vary over time. As a result of these factors and others, simply adjusting a general template for many pages cannot perform the fine-grained integration of embedded content, since the decisions whether to embed content and what content to embed is often a page-specific decision that changes over time.

The techniques discussed in this document address these challenges by allowing content to be presented inline with web pages and applications that the content provider does not control and cannot modify. Similarly, the system can be configured to provide content inline with other content that has not been created yet, such as web pages or web applications that are not yet available.

The techniques in this document also provide an efficient way for users to access information, such as analytics data, in a user interface. By allowing a user to call up an information card within existing user interface, the user no longer needs to switch applications and lose the context of the applications involved in the user's current task.

Traditionally, if a user is performing a task with an application and desires to look up information from an analytics platform or other database-backed platform, the user generally needs to switch applications or windows, log in, submit a query for the information desired, then wait for results to be returned. The delays, multiple steps required, and overall inconvenience often discourage users from looking up needed information.

By contrast, the techniques in the present application do not require the user to switch applications or interfaces, and contextually-relevant information is provided in the interface where the user needs the information. In addition, the information card that is presented can include an AI/ML chatbot interface that allows the user to ask questions about the data set, beyond viewing the initial information presented in the information card. This provides needed information to just the right user, time, and user interface where the information is needed. Delays are minimal because the client device can request and receive contents of the information cards before the user indicates that the information should be displayed, or the server can send content that includes embedded interactive functionality and information card content. The software agent on a client device can evaluate contents of the user interface, generate a query for a server system, and receive and format results for display so the information cards for each of multiple different terms are available for display before the user indicates the terms of interest. Also, the user can call up the information with a single action on the existing interface, such as a mouseover, click, or tap on an annotated term in the user interface.

Limited user interface space is conserved since the information card can be provided in the same window or area of the application the user is already using, with no need to switch between applications. Also, the information card is displayed and removed dynamically, so it is shown only when the user requests it. Unlike interfaces that include a dedicated, persistent area for content that may not be needed at most times, the present technique frees up more of the interface for use by an application.

The techniques discussed below also provide an efficient way to publish customized or private database content to users. The keywords or terms of interest to each organization can be set based on the private database contents for the organization. For example, each organization can have its own set of customers, employees, suppliers, product names, and so on reflected in its private database. Based on the database contents, terms have a semantic meaning that is specific to that organization, which the system uses to tailor the display of information for members of the organization.

In some implementations, the system provides an interface for an administrator to easily adjust the sets of terms that the system will highlight and make interactive for members of the organization by updating the database or identifying certain portions of a dataset. For example, an administrator can identify columns of a private database corresponding to employee names, customer names, and product names. The system extracts the contents of these columns and designates them as key terms for the organization. The current set of these terms can be downloaded to client devices of members of the organization when they authenticate to the software agents on the client devices, so each time the user authenticates the set of terms is refreshed at the client device based on the current state of the database. The information displayed in the information cards is also generated using the current records of the database. Thus, by designating certain records or fields from an organization's database, an administrator can adjust or update the set of content published to some or all members of the organization, which will be made available through many user interfaces (e.g., presented in-line with any web page or web application).

When a client device indicates that one of the key terms for the organization is present, the server system can access the underlying database record(s) corresponding to the term to generate relevant information to provide. The semantic meaning of the term that is applicable for the user and organization is used to provide customized results. For example, different types of information are provided based on the classification of the term, e.g., whether a term is the name of an employee, customer, or product. Different semantic classifications can have different data types or sets of information to be provided. Even for a particular classification, of the many potential types of data that may be provided, a subset can be selected based on analysis of the database contents (e.g., to identify trends or items that are popular, recent, or unusual according to various thresholds), relevance to the user (e.g., applicability to the user's historical behavior or role in the organization), and/or context (e.g., other keywords in the user interface, which may indicate geographical location, time, individuals, or other information relevant to the user's current task). In this process, the organizations security policies are preserved. If a user does not have authorization to access a field or record from the database, the server system will enforce access restrictions and will not provide the information. Consequently, different users even within the same organization may be presented different sets of information for the same term, due to the users' differing roles, interaction histories, access authorizations, and other factors.

In some implementations, a computer system provides functionality for creating and distributing customized interactive applications, such as chatbots, that provide responses using artificial intelligence or machine learning (AI/ML) models, such as large language models (LLMs). For example, the computer system can provide an interface through which a user, such as an administrator, can create or edit an interactive application. The computer system can provide an initial base application or template that includes the core functionality that enables users to obtain content from an AI/ML model. The administrator can use the interface customizations that alter the appearance and behavior of the interactive application, so the customized application provided to users will operate as the administrator intends. The customizations can include, for example, specifying the data sources available to be used in responding to user prompts (e.g., questions or statements input to a chatbot), as well as whether information from the Internet or other external sources can be used in generating responses. The interface also allows the administrator to set user access control and usage limits for the interactive application, to control resource consumption and costs incurred by repeated inference processing using AI/ML models.

After the administrator customizes the interactive application using the interface, the computer system saves the interactive application (e.g., as a new or updated chatbot) and makes the application available to other users. For example, the computer system can send hyperlinks or invitation messages to users, so the users can access a customized chatbot through a web page or web application. As another example, the computer system can include code to integrate the customized chatbot into an existing web page or web application (e.g., as an embedded item, in an iFrame, etc.). As another example, the computer system can integrate with document libraries, file browsers, document viewers, web browsers, or other types of user interfaces. As a result, the customized chatbot can be made available through any of various enterprise software platforms and applications. The interface of the customized chatbot can then be invoked by interacting with an icon or menu item for the customized chatbot, or by entering a user prompt into a text entry field of a user interface. In some implementations, the interface of the chatbot can be provided together with a document viewer, for example, in a sidebar or tab shown concurrently with the document viewer interface. This arrangement can enable the user to view a document, such as a dashboard related to a dataset, while concurrently having a conversation with a customized chatbot designed to answer questions about the dataset.

The computer system enables interactive applications to be tailored or targeted for specifics data sets. For example, each interactive application that is created or customized can provide responses with information derived from a corresponding data set specified by the administrator, such as a private data set (e.g., a database table, a data cube, a spreadsheet, etc.). The system enables administrators to create and deploy multiple interactive applications concurrently. For example, different chatbots that have different behavior tailored for different sets of users. Similarly, different chatbots can be configured to provide data from different source data sets. Administrators can create and deploy different instances of chatbots and other interactive applications, each with customized behavior, appearance, and other characteristics as appropriate for their respective data sets and users.

The computer system enables administrators to customize AI/ML-enabled chatbots very quickly, without the need to re-train an AI/ML model. In particular, after specifying the customizations for the chatbot, no model training is needed and so the customized chatbot can be used right away. The system can provide a preview interface or test interface that enables an administrator to change chatbot settings and try out the updated chatbot in the generation or editing interface, to see the effects of changes in real time or near real time. To facilitate customizability and the rapid generation of chatbots, the customizations to the chatbot can be made outside the training state of the AI/ML chatbot itself, for example through the selection of which existing AI/ML model(s) to be used, which dataset(s) being used, which portions of a dataset are accessible, and the parameters or characteristics of interactions with the AI/ML model(s). Customizations can also be implemented in operations of a non-AI/ML processing system, for functions such as access control, precision or granularity of data access, and so on. With the ability to provide customized chatbots without the need to train or re-train AI/ML models, the system allows rapid generation and deployment of chatbots with minimal up-front computing resources and no training delay.

The computer system can support interactive applications where processing tasks for responding to a user prompt are split between non-AI/ML or non-probabilistic data processing systems AI/ML models (e.g., database management systems) and AI/ML models. For example, when a user prompt such as a natural language query is received, the computer system can use a database system to generate a set of result data that is relevant to the user prompt. The set of result data can then be processed using one or more AI/ML models, such as a large language model, to generate content to present in a response to the user. This system can combine the strengths of AI/ML models and non-AI/ML processing systems to provide a chatbot or other application with responses that are more complete, accurate, and reliable than either type of processing system on its own.

In general, many AI/ML models have excellent generative capabilities and the ability to produce high-quality natural language output. However, AI/ML models also often have significant limits. For example, AI/ML models typically use probabilistic processing, which may generate responses that are generalized or approximate, and so may not adequately answer a user's question or may lack the accuracy or precision needed. In some cases, AI/ML models provide content that includes hallucinations or other information that may be statistically plausible given training data but is actually factually incorrect. The probabilistic nature of AI/ML models can also result in the same user prompt resulting in significantly different responses at different times, which can decrease users' confidence and ability to rely on the responses. For example, the same question may yield different numerical answers when the question is asked multiple times to an AI/ML model, even when the source data set has not changed.

As discussed further below, the computer system can provide chatbots and other interactive applications that combine the advantages of AI/ML models and the reliability and accuracy of other non-AI/ML or non-probabilistic data processing systems, such as relational database systems. Database management systems and other systems can reliably provide result data that is accurate and reliable, calculated from the source data using proven and validated processes. For example, data processing systems can be used to search a data set and make calculations, perform aggregations, and generate values in a data series in a repeatable or deterministic manner. This can be done even over large data sets, which may be much larger than an AI/ML system can accept as input context. In addition, the processing can be focused on the specific data set of interest, without extraneous data influencing the calculations as might occur in the probabilistic processing of an AI/ML model trained on large quantities of other data.

When the interactive application is used to respond to a user prompt, the non-AI/ML data processing system (e.g., a database management system) generates result data relevant to the user prompt (e.g., user's question) from the source data set. The user prompt and the result data set, potentially with other information and context, can be provided to the AI/ML model to generate text output for the response to the user. For example, the computer system can send a request for the AI/ML model to summarize the result data set or to generate a response to the original user prompt from the result data set that has been generated. As a result, the text that the AI/ML model generates can draw from values calculated accurately from the source data set, without requiring the AI/ML model to be capable of generating those values itself or without the AI/ML model even accessing the data set. As a result, the output to the user combines the reliable, accurate calculations from the non-AI/ML system with the text and other information provided by the AI/ML model from the result data set.

Combining the processing of AI/ML systems and non-AI/ML systems in the chatbots enhances privacy by limiting the amount of data that the AI/ML model or any other third parties receive. This can provide users with higher confidence in using the system, as well as allow the use of a wider range of third-party AI/ML service providers. When processing queries relating to a data set, the AI/ML model does not need to receive the full contents of the underlying dataset that the chatbot is based on. Indeed, in many cases, the AI/ML model does not receive even portions of the actual dataset, and instead receives only metadata describing the general contents and/or structure of the data set (e.g., types of metrics and attributes, semantic meaning of the columns, etc.) and potentially sample data (e.g., fictitious examples that illustrate the type of content in the dataset without revealing the actual values and records). In addition to enhancing privacy, this also increases speed and reduces network transfer requirements, since the dataset does not need to be sent over a network and the dataset itself does not need to be processed by the AI/ML model. The process also allows the data processing system (e.g., an enterprise database management system) to reliably apply security policies and access control over the dataset that the AI/ML model typically would not be capable of applying. After the data processing system performs processing to generate a result data set, the AI/ML model is provided the result data set and asked to generate a summary. In this interaction, the AI/ML model receives the result data set that generally includes aggregated or composite information specifically answering the user's question, and the AI/ML model does not receive access to the underlying dataset itself. As a result, the system avoids granting the AI/ML model- and any third-party providing the AI/ML model as a service-access to portions of the dataset that are not appropriate for answering the current question.

The customizations that the administrator set in creating or customizing the chatbot can be used to alter the operation and results of the non-AI/ML data processing system, the AI/ML model, the front-end interface that the user sees, or a combination of any or all of them. For example, the customizations that the administrator selects can specify which dataset(s) to use when answering questions, whether additional public datasets or the Internet can be used to answer questions, which portions (e.g., columns, rows, data types, etc.) of datasets can be accessed, and so on. In addition, the customizations that the administrator selects can specify output characteristics for the chatbot such as the style, formatting, media type (e.g., text, images, text and images, etc.), and other properties of answers.

In some implementations, the customized chatbots can be configured to generate visualizations in response to questions and other user prompts. These visualizations can also be generated through a combination of processing by AI/ML models and non-AI/ML processing systems. For example, if a user prompt requests a visualization or if a visualization is otherwise appropriate for a response, the AI/ML model can specify the type of visualization (e.g., bar chart, line graph, pie chart, etc.) and other properties (e.g., data series shown, scale and data on the axes, etc.). The actual values to be displayed in the visualization, however, can be calculated by the non-AI/ML processing system, using reliable and accurate calculations from the data set. As a result, the AI/ML system can design and format a visualization appropriate to answer the user prompt, while the actual data populating the visualization is not subject to the uncertainties of AI/ML processing.

In general, splitting response generation among multiple processing systems, e.g., an AI/ML model and a database management system, increases the quality of output and control over the process of generating responses. The arrangement also facilitates customizability by allowing administrators to select different AI/ML models and different AI/ML service providers to customize their chatbots. With the system performing discrete operations leveraging AI/ML models, separate from the core querying of an enterprise's proprietary datasets, the chatbots can be more easily integrated with the processing capabilities of third-party systems.

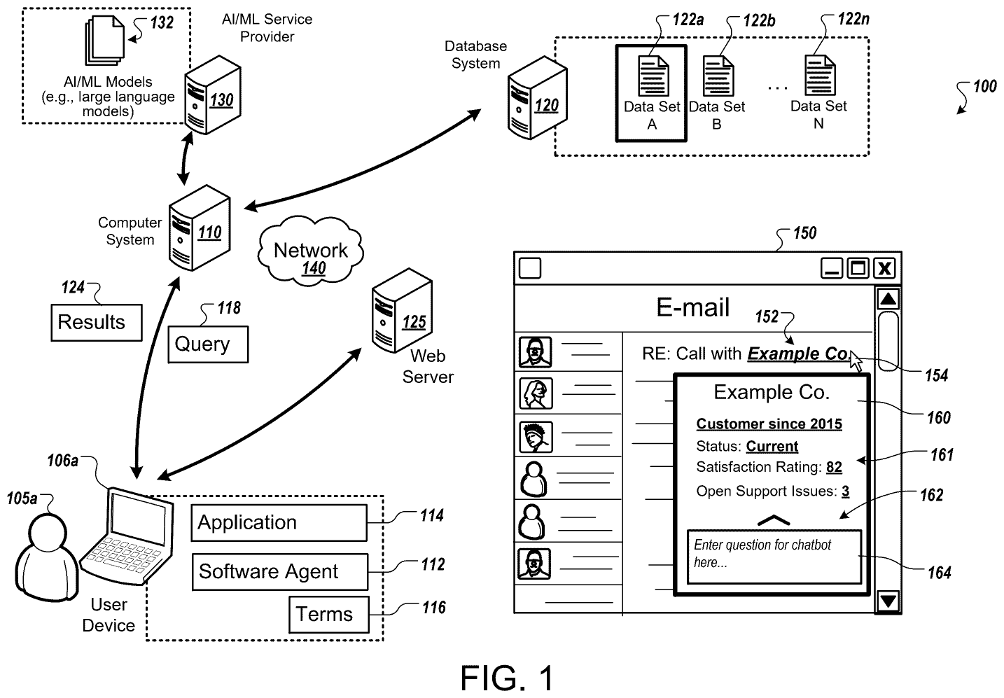

FIG. 1 is a diagram of an example of a system 100 for contextual delivery of database content and access to AI/ML chatbots. The system 100 includes a user device 106a, a computer system 110, a database system 120, an AI/ML service provider 130, a web server 125, and a network 140.

The computer system 110 communicates with the database system 120 that has access to private data sets 122a-122n for an organization. For example, the computer system 110 can be an application server and the database system 120 can be a database server. The computer system 110 and the database system 120 may be implemented using one or more multiple computers that cooperate to perform the functions discussed below, and which may involve multiple computers or cloud computing platforms and may be located remotely from each other.

The user device 106a includes an application 114 as well as a software agent 112 that enables the user device 106a to dynamically generate and display contextually-relevant information cards displayed inline with the application 114. As discussed below, the software agent 112 allows the user device 106a to obtain and provide information from the private data sets 122a-122n with the application 114 and web page from the web server 125, even if the application 114 and web page are controlled by third parties.

The user device 106a is associated with a user 105a, who is a member of an organization, e.g., an employee of a company. The private data sets 122a-122n represents database records stored by or for the organization. In the example, the records are not publicly available and are subject to data access restrictions, such as requirements that users be issued credentials from the organization that grant authorization to access the records. Different users may be granted different levels of authorization, and the computer system 110 enforces access restrictions so that each user is only allowed to access the subsets of information the user is authorized to access.

Traditional analytics platforms generally incorporate analytics content into the body of a document, using an iFrame or similar technique. This approach can be inefficient, because each application or web page generally needs to be updated individually. Further, this type of embedding may not be possible when the content provider does not control the target application or web page for content to be embedded into. For example, an organization cannot change the standard e-mail application interface that a third party provides.

In the system 100, instead of incorporating additional content into the source of a document or application, information is instead provided to users, just in time, through the software agent 112, for example, a browser extension for a web browser. This provides the flexibility for the system to selectively provide dynamically changing content from the private database for any interface shown on the application 114, e.g., any web application or web page displayed by a web browser. In addition, a dynamic set of content from a data set 122a-122n can be surfaced through interactions of the user through the chatbot user interface that is included in or associated with an information card.

In the example of FIG. 1, the user device 106a communicates with the web server 125 to obtain and display a page of a web site or web application in the application 114. The user device 106a generates a user interface 150 for the application 114. Concurrently, the software agent 112 runs on the user device 106a and receives, from the application 114, the text content of the rendered page, e.g., user interface 150.

The software agent 112 may require the user 105a to authenticate and thus prove authorization to receive content from the private data sets 122a-122n. The authentication of the user 105a can also indicate to the software agent 112 and/or computer system 110 the role of the user in the organization (e.g., software engineer, marketing technician, financial analyst, and so on) and the specific level of access authorization that has been granted to the user 105a by the organization.

With the user logged in, the software agent 112 accesses a set of terms 116, e.g., words and/or phrases, that are relevant to the user 105a and the organization. The set of terms stored at the user device 106a. In some implementations, the set of terms 116 is requested and received from the computer system 110 each time the user 105a authenticates. The set of terms can represent values from certain fields of the private data sets 122a-122n, for example, values representing names of customers of the company of the user 105a.

The software agent 112 compares the terms 116 with the text of the user interface 150 to identify matching terms. When the software agent 112 identifies one or more matches, it generates a query 118 that indicates the matches and sends the query 118 to the computer system 110. In some implementations, the software agent 112 also examines the text of the user interface 150 to identify and include in the query 118 other contextual factors that may be of interest (which may be different from the terms 116 of interest), such as terms indicating a time or a geographical location indicated in the user interface 150, or a task of the user 105a that may be indicated in the user interface 150. Various words and phrases indicating an overall subject or topic of the user interface 150 may also be extracted and provided in the query 118.

The computer system 110 coordinates data retrieval with the database system 120, so the database system 120 processes the query 118 and generates results 124 using the contents of the private data sets 122a-122n. These results 124 can indicate, for each identified matching term, various indicators (e.g., attributes, statistics, visualizations, text, or other content) relevant to the term. In some instances, the indicators can represent key performance indicators for an entity referred to by an identified term with respect to the specific organization of the user 105a. For example, when the term refers to a customer of a company of the user 105a, one of the indicators may specify a product of the company that was purchased by the customer, current or forecasted sales of the company to the customer, etc.

The user device 106a receives the results 124 from the computer system 110. The software agent 112 annotates instances of the identified matching terms in the user interface and prepares the results 124 for display. For example, to annotate the matching terms, the software agent 112 may instruct the application 114 to highlight the term or otherwise change the formatting of the term (e.g., color, font, size, bold, italics, underlining, etc.) in the user interface 150. In some implementations, the results 124 are not immediately displayed. Rather, the software agent 112 causes the matching terms to become interactive, so that interaction of the user with a term triggers display of an information card for that term. In this manner, when a user indicates interest in one of the terms, e.g., by placing a mouse cursor over the term, the software agent 112 is notified of the interaction and causes an information card with the indicators relevant to the term to be displayed. The information card can be displayed overlaying a portion of the original user interface 150, for example, as a pop-up card near the instance of the term that the user interacted with. The software agent 112 also detects when the user 105a is no longer interested in the information card and automatically removes (e.g., closes or hides) the information card in response. For example, when the user moves the cursor away from the interactive term and away from the information card (or taps or clicks outside the interactive term and information card), the software agent 112 hides the information card.

In FIG. 1, the software agent 112 has determined that the user interface 150 includes a term 152 “Example Co.,” which is one of the terms 116 relevant to the organization of the user 105a. The software agent 112 has received results 124 that indicate indicators for this term 152, which represents a customer of the organization of the user 105a. In response to identifying the matching term 152, and in some instances also receiving results 124 from the computer system 110 for the matching term 152, the software agent 112 makes the term 152 interactive and causes the term 152 to be annotated, in this case, displayed bold, underlined, and in italics.

Initially, before user interaction with the term 152, the software agent 112 does not cause display any information card or the retrieved indicator values associated with the “Example Co.” entity. However, when the user moves the mouse cursor 154 over the term 152, or otherwise interacts with the term 152, the software agent 112 detects the interaction and displays an information card 160 showing various indicators 161 provided by the computer system 110 (as determined from data from the database system 120) in the results 124. These values can be a predetermined set of metrics and/or attributes for the entity that are specified in a card template or card definition for entities of the “company” type. The information card 160 also includes a chatbot interface 162, which includes a text input field 164 configured to receive input of a user prompt to send to a chatbot.

The chatbot interface 162 provides communication with a chatbot that was previously associated with the card template or card template used to generate the information card 160, such as a chatbot that is configured to access and provide answers about data in the same data set 122a (or multiple data sets) used to generate the values of metrics and attributes specified in the information card 160. The computer system 110 can store information that specifies the configuration of information cards and chatbots, including the associations or linkages between them. For example, the computer system 110 can store data that indicates, for each of various information card types (e.g., different card templates or card definitions), which chatbot is to be used to answer questions through the displayed chatbot interface of the information card. Using this stored configuration data, the computer system 110 can route questions from each chatbot interface to the correct chatbot. In many cases, an organization may have various different chatbots, including chatbots with different capabilities or access to different data sets.

When a user enters a prompt in the text input field 164 of the chatbot interface 162 and submits the prompt, the computer system 110 routes the prompt to the chatbot associated with the information card 160. The computer system 110 can host the chatbot functionality and can communicate with the AI/ML service provider 130 to have an AI/ML model 132 generate a response to the prompt. In this process, the computer system 110 can set the context and scope for answering the user prompt based on the information card 160. For example, the computer system 110 can include, with the user prompt, various types of context information representing the context of the information card 160, such as the term 152, the identity of the entity represented by the term 152, the indicator values 161 and the indicator types (e.g., names or semantic meanings of the indicators, such as which attributes or metrics are represented by the respective values), and so on. By providing the information card context with the user prompt, the computer system 110 grounds the processing of the AI/ML model 132 in not only the data set 122a for the information card 160 but also the topic or data context viewed by the user 105a (e.g., the particular entity “Example Co” and the displayed metrics and attributes). This can greatly improve the quality and relevance of chatbot responses, by helping the AI/ML chatbot to disambiguate terms in the user prompt and to understand references that the user prompt may include to items in the information card 160. These items of context do not restrict the chatbot to answering only about the displayed types of information however. The chatbot interface 162 is designed to provide the user to access additional data in the underlying data set 122a associated with the information card 160, beyond what is visible in the information card 160.

In some implementations, if specified in a setting by the creator of the information card definition or card template, the computer system 110 can restrict the topic or scope of conversations through the chatbot interface 162. For example, the computer system 110 can limit the conversation to the topic of the particular entity, “Example Co.,” that is the subject of the information card 160. The computer system 110 can do this by including a custom instruction to the AI/ML model 132 for prompts received through the chatbot interface 162, that instructs the AI/ML model 132 to answer only about the particular entity corresponding to the information card 160. In addition, or as an alternative, the computer system 110 can limit the chatbot's use of the data set 122a when answering questions through the chatbot interface 162, so that the database system 120 only retrieves and provides a subset of data from the data set 122a that is related to the particular entity. For example, when managing data retrieval from the database system 120 for the chatbot, the computer system 110 can add or apply data processing criteria (e.g., a filter setting, a structured query language (SQL) command or element, etc.) that limits data retrieval to data about the particular entity associated with the information card 160.

In some implementations, the computer system 110 manages chatbot functionality to permit conversations through the chatbot interface 162 to access any of the data in the data set 122a corresponding to the information card 160. As a result, even though the information card 160 is for Example Co., if the user asks for information about an another company through the chatbot interface 162, the chatbot would still be able to obtain the information from the data set 122a and provide a response. In fact, depending on the settings of the information card template and/or the chatbot, the chatbot may be permitted to use information for other sources (e.g., other data sets 122a-122n, web pages, documents, etc.) in generating its response.

As discussed further below, when the user communicates with the chatbot, the user device 106a can expand the chatbot interface 162 to provide room for user prompts and chatbot answers, in some cases covering or replacing some or all of the other content in the information card 160, and potentially filling the area of the information card 160.

When the user 105a is done reviewing the information card 160 and/or using the chatbot interface 162, the user 105a can move the cursor away or click away from the term 152 and information card 160, and the software agent 112 automatically hides the information card 160 until the user 105a again interacts with the term 152. In some implementations, hiding the card may be done gradually or with a delay of a few seconds to avoid inadvertent dismissal of the information card 160 and potential loss of the conversation with the chatbot. In some implementations, once the user begins interacting with the chatbot, e.g., by starting to type a prompt or by selecting a suggested query, the information card no longer disappears if the user moves or scrolls away. Once a conversation with the chatbot has begun, the user may be required to affirmatively close the information card, so that the conversation does not disappear and the user does not lose the conversation in progress.

In addition, the chatbot interface 162 can provide interactive controls (e.g., icons, buttons, etc.) or other functionality to allow a user to save or persist content from chatbot conversations. For example, chatbot answers can be provided with buttons that the user can click to copy chatbot answers to the clipboard, to save chatbot answers to a disk, to send or share chatbot answers (e.g., via email, text message, messaging platforms, etc.), to save the chatbot answer as a “snapshot” or saved answer stored and accessible through other chatbot interfaces (e.g., not only through information cards, but other integrated or stand-alone chatbot interfaces), and so on. As another example a control can be provided that, when interacted with by a user, causes the information card 160 (e.g., including the displayed indicator values or attribute or metric values) and/or the chatbot interface to be moved and pinned to a sidebar or other interface region, so it persists even after the information card 160 itself is dismissed or automatically hidden.

The software agent 112 can receive and examine the content of the user interface 150 of the application 114 on a recurring or ongoing basis. For example, as the user 105a navigates to a new web page or a new view of a web application, the software agent 112 examines the updated content of the user interface 150. The software agent 112 finds matches in the updated interface, requests and obtains new results for the updated interface, and causes new sets of terms to be annotated and made interactive, allowing the user 105a to access information cards for key terms for whatever interface content may be provided in the application 114. The software agent 112 can receive and analyze user interface content in substantially real time. For example, if the user 105a composes an e-mail message, the software agent can detect matching terms in text that the user types, in some instances while the user is still typing, and annotate matching terms in this content.

The system can provide very low latency for users to receive information regarding key terms in a user interface. Because the software agent 112 can identify terms and obtain terms automatically and in the background, in many instances the information needed for an information card 160 is already present at the user device 106a before the term is annotated. Consequently, when the user interacts with an annotated term, the corresponding information card 160 can be displayed very quickly, often within a second or less. This provides users a very fast response while also allowing access to the information from the private data sets 122a-122n, whether through the initially presented indicators 161 or as obtained through conversation with the chatbot, without having to leave the user interface 150 of the application 114.

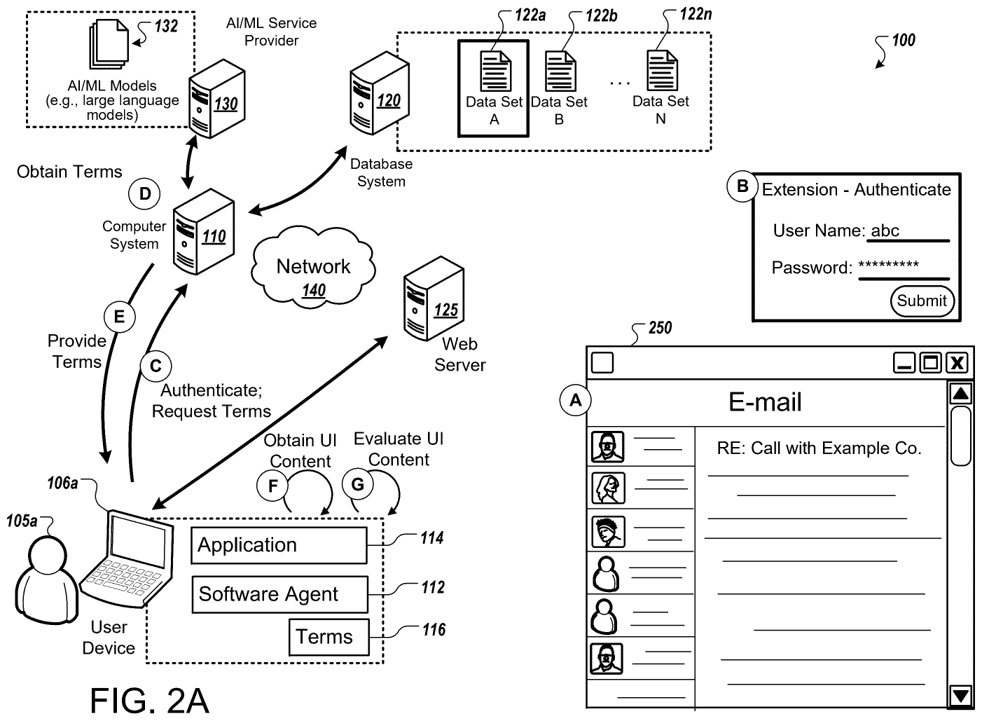

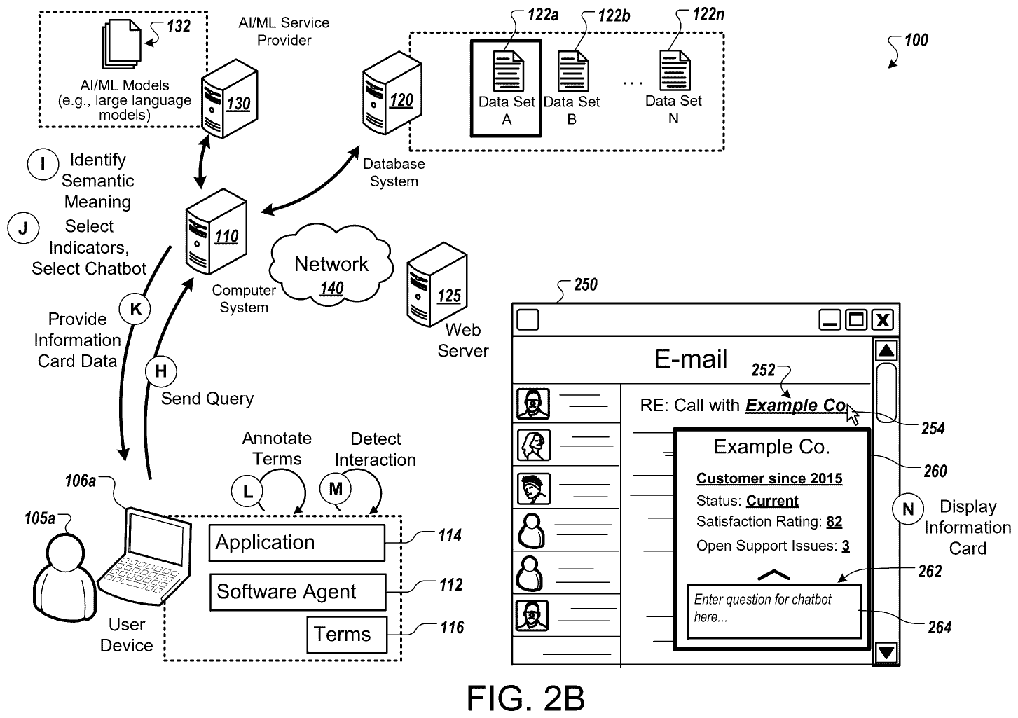

FIGS. 2A-2B are diagrams illustrating another example of the system 100 for contextual delivery of database content and access to AI/ML chatbots. FIGS. 2A-2B illustrate various operations of the system 100 in greater detail. FIGS. 2A-2B illustrate various operations and flows of data represented as stages (A)-(N), which can be performed in the order shown or in a different order.

As in FIG. 1, the computer system 110 has access to a private data set 122a for an organization. The user device 106a includes an application 114 as well as a software agent 112 that enables the user device 106a to dynamically generate and display contextually-relevant information cards displayed inline with the application 114 (e.g., as a pop-up or overlay region). As discussed below, the software agent 112 allows the user device 106a to obtain and provide information from the private database 122a with the application 114 and web page from the web server 125, even though the application 114 and web page are controlled by third parties.

In stage (A), the user device 106a obtains and displays content from the web server 125 in the user interface 250.

In stage (B), the user 105a authenticates to the software agent 112, e.g., a web browser extension or add-on for another type of application 114. For example, the software agent 112 may prompt the user 105a to log in, or the user may click an icon for the software agent 112 to initiate log in. The user 105a can enter a username and password, or alternatively authenticate in another form, e.g., through biometric data entry, entry of a PIN code, etc.

In stage (C), the software agent 112 communicates with the computer system 110 to authenticate the user 105a. The software agent 112 may optionally request updated information from the computer system 110, such as a set of terms 116 representing keywords relevant to the user 105a and an organization of the user 105a.

In stage (D), the computer system 110 completes the authentication of the user 105a. Once it is determined that the received credentials are valid and are authorize access to information from the private database 122a, the computer system 110 obtains the current set of terms or keywords that are applicable for the user 105a and the user's organization. This can involve extracting information from the private database 122a, for example, extracting values from certain columns or fields of the database, such as extracting values representing names of entities or objects. Terms may additionally or alternatively be extracted based on having certain metadata tags or data types associated with them. Other terms, such as abbreviations, nicknames, and other identifiers can also be included. The terms may be filtered based on the access permissions of the user 105a, the role of the user 105a (e.g., department, job title, responsibilities, etc.), and other factors.

In stage (E), the computer system 110 provides the terms to the user device 106a for storage and for use by the software agent 112. These terms can be set by an administrator for the system 100. In some implementations, the set of terms is generated by the server, for example, by pulling terms from a portions of a database or other data source. For example, the computer system 110 may access database tables that list entity names (e.g., for competitors, suppliers, partner organization, employees, customer contacts, etc.) as well as abbreviations and/or nicknames for them. Based on the identity and role of the user 105a, the computer system 110 may filter the list, e.g., limiting the extracted set of terms to those having information determined to be relevant to the role of the user 105a and also those for which the user 105a has security permissions to access corresponding data. The set of terms may be further limited to terms for types of entities for which appropriate information card templates have been defined. The filtered list of terms can then be provided to the user device 106a. The database may be queried dynamically each time to obtain an up-to-date set of key terms each time a new set of terms 116 is requested.

In some implementations, the user 105a may be able to customize the set of terms that are annotated and made interactive to be able to trigger display of an information card. For example, the software agent 112 may provide a user interface allowing a user 105a to edit the list of terms, e.g., to add or remove terms from the set that will be identified and annotated in the future. These changes can be customized for the specific user identity of the user 105a who is logged in and/or for the specific user device 106a used. The user interface may allow edits for individual terms, or for groups or categories of terms. This ability can allow a user to limit the terms that will be annotated to the set that the user is specifically interested in. Similarly, it can expand the set of terms to include terms that may not be directly related to the user's role but still relate to the user's interests.

The terms 116 can be terms other than proper names. For example, for an engineer, the terms 116 may additionally or alternatively may include component types, product names, or technical terms. Corresponding information cards may indicate a variety of types of information. For a component, a card might provide specifications, indicate suppliers, provide links to datasheets, identify products that use the component, etc.

In stage (F), the software agent 112 obtains user interface content from the application 114. For example, the software application 112 obtains text content from the user interface 250. This can include the entire content of the rendered page, document, or view, not only the portion that may be currently visible on screen (e.g., due to the current scrolling position).

In stage (G), the software agent 112 evaluates content of the user interface. For example, this can include comparing text from the user interface 250 with the terms 116 provided by the computer system 110 and stored at the user device 106a, to identify matching terms that should be annotated and for which information cards may be generated.

In some implementations, the software agent 112 and/or the computer system 110 may analyze text of the user interface 250 to identify or generate indicators to be displayed. Through analysis of the text of the UI, the software agent 112 and/or the computer system 110 can, in real-time, produce indicators and other information on the fly, without the indicators being previously designed by a human author or administrator. For example, if the software agent detects there are multiple instance of an attribute combined with time and geographical dimensions, through interactions with the computer system 110, the software agent can produce specific aggregations of data for the indicated time and geography and present the information in an information card. To carry out this function, the computer system 110 can access a semantic graph to enable interpretation of content as it relates to a business or other entity, provide a summary, and link to more details, all of which can be produced dynamically. The semantic graph can indicate, for example, the attributes of an entity and may indicate where to locate data for the attributes from the private database 122a.

As an example, from text in a web page, the software agent 112 may identify words in various semantic categories. As an example, along with a keyword “Example Co.,” the extension may identify the terms “Q2,” “Florida,” “subscribers,” and “2016” which are not keywords corresponding to specific entities of interest, but nonetheless have a semantic meaning identified by the software agent 112. From these additional terms, the software agent may compose one or more indicators to be requested from the database computer system 110. For example, the software agent 112 may generate a query that requests a number of subscribers from Example Co. were added in Florida from April to June of 2016. Similarly, the software agent 112 may generate a query requesting a total number of subscribers from the company for the same period and location. In addition, or as an alternative, the software agent 112 may provide the terms with semantic meanings to the database computer system 110, and the database computer system 110 can identify appropriate indicators from the terms.

Referring to FIG. 2B, in stage (H), the software agent 112 generates a query that indicates which terms 116 were identified in the user interface 250. The query can additionally include other contextual information, such as indications of time, geographical location, or topic that the software agent 112 identified in the content from the user interface 250. The software agent 112 causes the user device 106a to send the query to the computer system 110.

In stage (I), the computer system 110 identifies a semantic meaning for each identified term that the query indicates. As part of identifying a semantic meaning, the computer system 110 may select a semantic classification from among multiple predetermined semantic categories. The semantic meaning is generated using the information of the private database 122a and so can be specific to the user 105a and the organization of the user. For example, one company may be a supplier for one organization and a customer of another. Similarly, even within one organization, an individual may be the supervisor of one user but a peer of or may be supervised by a different user. Thus, the interpretation of the terms can vary based on the relationships indicated in the private database 122a and can vary from one organization to another, from one user to another, and over the course of time.

In stage (J), the computer system 110 determines the content of an information card based on the identified term. This can include selecting, for each identified match to the terms 116a, a layout for an information card, a chatbot to provide access to in the information card, and indicators (e.g., metrics and/or attributes) to present in the information card. The computer system 110 also requests values for those indicators from the database system 120, which retrieves or calculates values for each type of indicator selected. These indicators or types of values to show may be any of multiple types of values. For example, some indicators may be attributes or database field values retrieved directly from a database or other data source. As another example, indicators may be results of aggregation of data from one or more databases, or may be results of processing data with equations, formulas, functions, or models.

The type of content to be included in the information card can be specified in a card definition or card template. The computer system 110 can store various card definitions corresponding to different entity types, e.g., a card definition for companies, another card definition for employees, another card definition for customers, etc. Each card definition can specify which indicators to display, the layout of those indicators, and other card properties. In addition, each card definition can specify whether a chatbot interface should be included in the information card, and if so, which chatbot the interface should provide access to. The card definition can also specify other properties, such as whether chatbot conversations through the interface are limited to the subject entity of the information card, if any additional data sources are made available to the chatbot for conversations made through the chatbot interface of the information card, and so on.

For example, the computer system 110 may select the indicators to be provided using one or more templates or card definitions that specify which indicators to use in information cards corresponding to different types of entities. For example, a template specifying a first set of indicators may be used for entities classified as suppliers, while a template specifying a different set of indicators may be used for entities classified as customers. As another example, companies, people, locations, and products may each have different templates or sets of indicators predefined, since each may have different attributes or characteristics of interest. Both of these can be used together also. For example, a first set of the indicators may be determined based one classification of an entity (e.g., person, place, object, . . . ) while a second set of the indicators may be determined based on a different classification for the entity (e.g., supplier, customer, competitor, etc.) The templates may indicate formatting and layout for information cards as well as the types of indicators that should be provided.

As noted above, for each matching term, the computer system 110 determines a semantic classification of the term, e.g., a category or classification of the term and/or identifying an entity that the term refers to (e.g., where the entity may be a particular person, company, object, etc.). The computer system 110 also accesses one or more records from the private database 122a. The types of records accessed may vary based on the semantic classification. For example, when the term is a customer name, the data may indicate indicating attributes of the customer (e.g., size, geographical presence, industry, etc.), financial records for the customer (e.g., products purchased, historical and predicted sales amounts, etc.), contact information for representatives of the customer, and so on. When the term is determined to refer to an employee, the accessed records may indicate the department of the employee, the responsibilities of the employee, the supervisor of the employee, the length of time the employee has been with the company, and so on.

For each semantic category, the computer system 110 can have a number of potential indicators or types of data that can be provided. These indicators can take any appropriate form, such as text, numbers, icons, charts, graphs, images, etc. In some instances, the indicators can represent key performance indicators for an entity referenced by an identified term with respect to the specific organization of the user 105a. For each matching term identified in the user interface 250, the computer system 110 selects a subset of the available indicator or data types to provide in the results 224. This subset can be selected based on various factors. In some implementations, a predefined set of indicators is pre-associated with different semantic classifications. As a result, one set of indicators is provided for customers, another set of indicators is provided for employees, another set of indicators is provided for suppliers, and so on. One way that the computer system 110 can implement this is to have templates defined for each semantic classification, where the template indicates data types of indicators that are set to be provided for terms having that classification. Each indicator can have one or more references to data within the database, e.g., a column or field type of the private database 122a used to obtain or generate the indicator, as well as corresponding equations for generating the indicator and criteria such as threshold for evaluating the indicator.

In some implementations, at least some of the indicators are selected dynamically based on analysis of the contents of the data set 122a. This process can be done to modify (e.g., filter and/or supplement) a base set of indicators pre-associated with a semantic classification or to generate the set of indicators directly. The indicators to be provided are selected from what is available or what can be calculated from the information in the private database 122a and optionally other data sources. From the available indicators, the computer system 110 can apply various thresholds to determine which indicators are most relevant. For example, if an indicator deviates from a historical average or range by more than a threshold amount, the indicator can be indicated selected. Similarly, if an indicator relates to a recent or upcoming event occurring within a threshold amount of time from the current time, the indicator can be selected. In general, each indicator can be assigned a score for each of multiple factors, the indicators can be ranked based on the scores, and the highest-scoring indicators can be selected to provide to the user device 106a in the results 224.

The indicators can also be customized based on the role of the user 105a in the organization. For example, the computer system 110 can look up a job title, department identifier, or other classification of the user 105a, and also access data specifying indicators relevant to that classification. As an example, a user indicated in company records as a financial analysis may be provided financial metrics for a customer, while a user indicated as an engineer may be provided technical information about a product sold to the customer. The indicators selected can be further customized based on the historical interaction of the user 105a. For example, based on records of interactions of the user 105a with prior information cards, the computer system 110 can determine which indicators are likely to be of interest to the user 105a for different types of entities.

The computer system 110 may use various other techniques to select indicators, including predefined indicators for specific classifications or specific entities, user interactions data for multiple users, user preferences of the user 105a, prior behavior of the user 105a, artificial intelligence or machine learning, analysis of trends, news and recent events, and so on.

In some implementations, the computer system 110 tracks user interactions and learns from user behavior. For example, the computer system 110 can monitor interactions with information cards, based on telemetry data provided by the software agent 112 over the network 140, and adapt the current information card or later-provided information cards in response. The system 110 can track any of a variety of interaction parameters, such as how long an information card is displayed, how many times the information card is caused to be displayed, whether a user moves a cursor over a UI element (e.g., a mouseover), how long the cursor hovers over the UI element, whether a UI element is selected or copied to a clipboard, etc. Information cards can have interactive elements also, e.g., buttons, scrolling controls, drop-down lists, hyperlinks, sliders, dials, maps, embedded audio or video, and so on. These interactive elements may reveal additional indicators or allow a user to access additional content from the private database or other data sources. The system 110 can track interactions with these interactive elements as well.

The computer system 110 can customize the characteristics of information cards for users individually or based on aggregated information about interactions of multiple users. For example, according to the level of interaction that users have with indicators on the cards, the computer system 110 can change which types of indicators are selected, as well as the prominence, arrangement, or number of indicators presented. If one user frequently hovers over, selects, or copies to a clipboard information from a certain type of indicator for entities of a certain classification, the computer system 110 may generate future cards for that classification to show the indicator more prominently (e.g. larger or closer to the top of the card) and/or to include additional related indicators (e.g., showing the indicator with greater precision, or showing trends in the indicator over time, or showing other indicators of the same data type). As another example, if a user rarely interacts with certain types of indicators, those indicators may be made less prominent (e.g., smaller or lower in the card) or may be removed.

Tracking and adjustment of information cards can be done on a per-user basis, or for groups of users (e.g., users at similar roles or in the same department or organization), or across users generally. Similarly, tracking and adjustment can be done for certain classifications as a whole (e.g., across all entities or terms sharing a semantic classification), or tracking and adjustment may be done separately at the level of individual terms or entities. For example, two companies of the same semantic classification (e.g., both suppliers to an organization) may have different indicators shown in their information cards, or have a different arrangement of the indicators, due to different ways users interact with the respective cards.

The computer system 110 may apply security policies when selecting which types of indicators to use and when generating or providing values for the indicators to the user device 106a. For example, security policies may limit access to certain databases or portions of databases, and the computer system 110 may determine whether the user 105a has sufficient access privileges before providing (or even simply retrieving or computing) values for that depend on data that the user 105a is not authorized to access. In some implementations, database information may secure information at the level of a table, column, and/or row. As a result, collections of records, individual records, or even individual fields or elements of records may have security policies applied. If the computer system 110 determines that the value of an indicator would depend on data that the user 105a is not authorized to access, the computer system 110 does not provide the indicator value. Instead, the computer system 110 may omit that indicator, substitute the indicator for one that the user 105a is authorized to obtain, or cause a placeholder value such as “n/a” or “---” to be provided to indicate that the value is not being provided.

In some implementations, the computer system 110 maintains associations or links between terms and different data records or data sources. For example, the computer system 110 may store data mapping terms to data cubes used for online analytical processing (OLAP). Selecting the types of indicators and determining the values for those indicators can involve using the mapping data to retrieve data from the data cubes (or other forms of data storage). Other mappings may also be used. For example, different terms may mapped to a unique identifier, which is then mapped to other records. For example, the terms “Example Company,” “Example Co.,” “EC,” and other related terms may each map to a single entity identifier, which may then be used to retrieve information about the which indicators are relevant and what the values for those indicators should be.

In stage (K), the computer system 110 provides, to the user device 106a, information card data for the information card to be presented. The information card data can include text, code, markup language content, and other content that can be rendered by the user device 106a to display the information card. The information card data for a term or entity identified can include values for the selected indicators for the identified term. In the example, the selected indicators include a status of the “Example Co.” company with respect to the organization of the user 105a, a satisfaction rating indicating how satisfied the company appears to be as a client, a number of open support issues for “Example Co.” and contact information for “Example Co.” The server provides an indication of each of these indicator types, as well as a value corresponding to each indicator, e.g., a value of “current” for the status indicator, a value of “82” for the satisfaction rating indicator, and a value of “3” for the number of support issues. The information card data also includes the code or other content to cause a chatbot interface area to be displayed in the information card, as well as appropriate metadata or application programming interface (API) information so chatbot requests are routed to the correct chatbot.

In stage (L), the software agent 112 cooperates with the application 114 to annotate the identified terms in the user interface 250. For example, the term 252 is annotated in FIG. 2B. This process causes the annotated terms to become interactive. For example, the software agent 112 can register with the application 114 to receive notification of interaction events, such as a mouseover event, click event, tap event, etc.

In some implementations, when the application 114 is a web browser, the software agent 112 can inject code, such as HTML code and/or JavaScript code, into the content of a web page being browsed to cause annotations to be shown. The injected code may also listen for and respond to events, such as a click, mouseover, tap, or other interaction with annotated terms. When the application 114 is not a web browser, the software agent 112 may use other techniques, such as macros or APIs to cause terms to be annotated and become interactive. In a similar manner that a web browser accepts toolbars and extension modules, the application 114 may provide extension components to integrate with other types of applications as well. More generally, the software agent may provide overlay content to be placed on, around, or over the place where the term occurs. This may optionally be done through communication with the operating system rather than integration with a specific application.

In stage (M), the software agent 112 detects interaction with one of the annotated terms. For example, the user 105a moves a cursor 254 over the annotated term 252. The software agent 112 may detect the interaction by being notified by code that was injected into a web page, such as event handling code that notifies the software agent 112 of the user action. Other techniques may additionally or alternatively be used. For example, the software agent 112 may monitor user input events generally, with information provided by the operating system, for example. The software agent 112 may track the on-screen position of each annotated term, as well as the position of a cursor or user input, and thus detect when the user has interacted with one of the annotated terms.

In stage (N), the software agent 112 causes the display of an information card 260, for example, as an overlay or pop-up over the original user interface 250. The information card can include the indicators selected by the computer system 110 and provided over the network. In some implementations, the information card 260 can be displayed near, e.g., adjacent to or even partially or completely overlapping the annotated term 252. As illustrated, the information card 260 includes a chatbot interface 262 that includes a text input field 264 for a user to enter a prompt to the chatbot that is selected for use with information cards related to entities of the “company” type.

While various examples discuss annotating terms shown in a web page, the same techniques can be used to annotate and make interactive terms occurring anywhere in a user interface. Thus, terms in applications, documents, toolbars, controls, or any other part of a user interface can be annotated and made interactive to trigger display of an information card corresponding to the term.

As discussed above, the application can be a web browser, and the software agent can be a web browser extension. Nevertheless, the same techniques can be used to provide information cards for other types of applications and with other types of software agents. For example, a native application for word processing, spreadsheet editing, presentation editing, document viewing, etc. can provide an application programming interface (API) through which the content of the application can be provided to a software agent implemented as an application add-on module or extension. The software agent can integrate with or operate alongside a native application to identify keywords and dynamically display information cards as discussed herein.

In some implementations, when a user initiates a conversation with a chatbot through an information card, previous conversation history is not used for the new conversation. Instead, the context of the current information card (and/or the document or interface from which the card is triggered) is used without prior conversations. In many cases, the user may have conversed with the same chatbot in a different context, and that conversation would likely be different from and not as narrow as the context of the current topic, entity, or indicators (e.g., metrics and attributes) represented by the current information card.

In some implementations, the computer system 110 can alter the behavior or persona of the chatbot based on the document, website, or other interface from which the information card was triggered. For example, for cards displayed from keywords in pages in a particular website, the chatbot can be configured to make use of data of that website, or to customize the format of its answers for that website. For other websites, other outside data or other output customizations may be desired. As a result, the computer system 110 can determine the identity (e.g., source document, folder, category, Internet domain) of the document from which a card-triggering keyword is found, and then tailor the function of the chatbot accordingly, including selectively accessing different data sets based on the interface from which the card-triggering keyword was found.

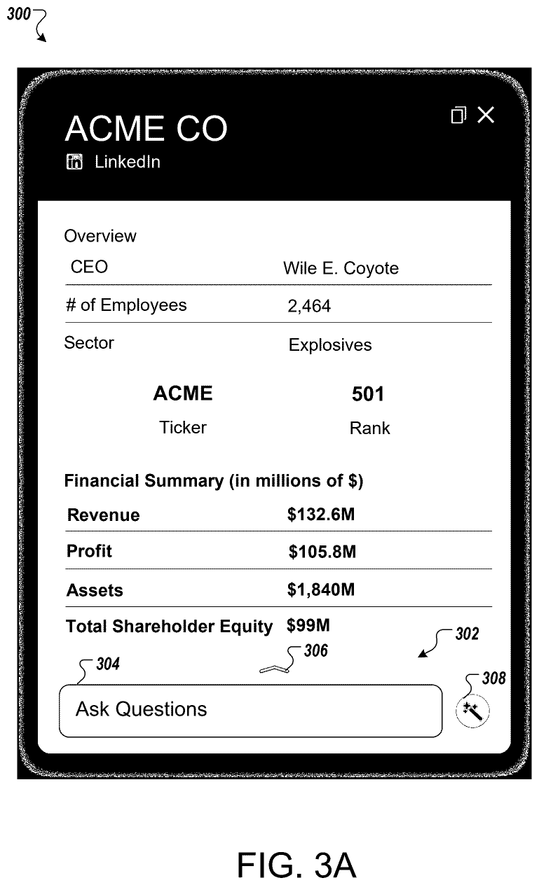

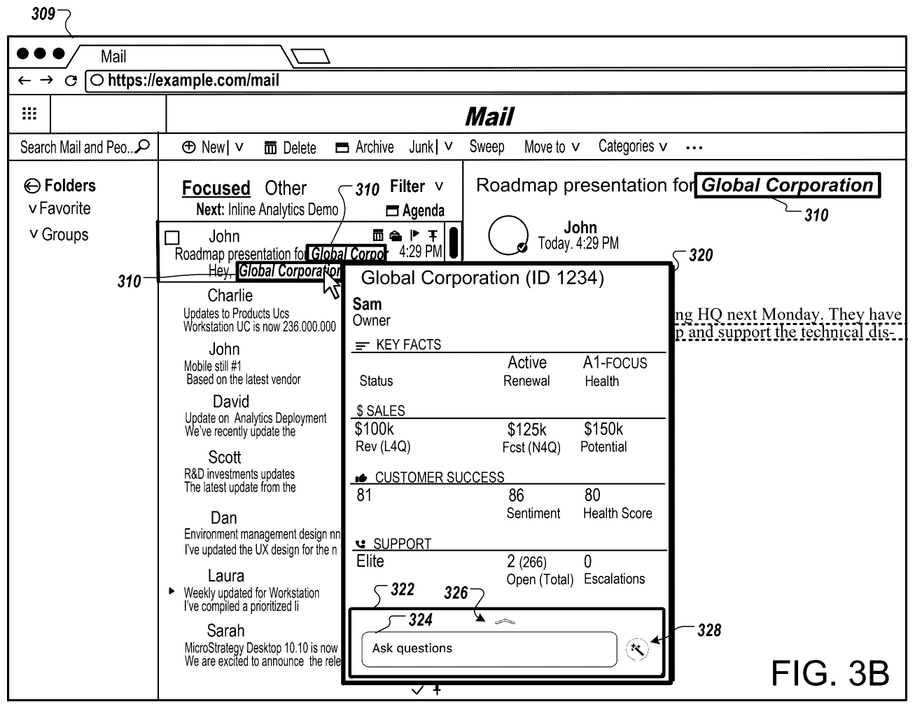

FIG. 3A is another example of an information card 300, which shows information about a company, “Acme Co,” and also includes a chatbot interface 302. The chatbot interface 302 includes a text input field 304 to receive user prompts, an expansion control 306 to expand the chatbot interface 302 to occupy more or all of the area of the information card 300, and a control 308 to initiate the presentation of suggested queries to the chatbot.

FIG. 3B is a diagram illustrating an example of a user interface 309 showing an information card provided in response to user interaction. In the example, the user interface 309 is one that may be provided by a client device, such as user device 106a above. The particular example illustrated shows a web browser and a web page providing information from a user's e-mail account. Upon navigating to the web page, the client device obtains the text content to be displayed, e.g., content of the web page, and checks the text content for matches with a set of key terms, e.g., words or phrases indicated by a server system or stored at the user device. As discussed above, each of the key terms has corresponding information in a database. A key term may refer to a particular entity, and the entity can have a particular information card template associated with it.

In FIG. 3B, after navigating to the web page shown in the user interface 309, the system has determined that the phrase “Global Corporation” is matches an entry in a list of key phrases. In response, the client device annotates each instance 310 of this term in the user interface 309, shown here by bold and italic formatting and a box around the term. Other types of annotations can be additionally or alternatively used. In this example, each instance of the key term is also made interactive.

When the user interacts with an instance 310 of the key term, the user device generates and provides an information card 320 corresponding to an entity represented by the term. As illustrated, the interaction can be a mouse-over event where a cursor rests on or near the annotated term for at least a minimum amount of time. This interaction can trigger the client device to request an information card from a server system. The information card 320 can include any of various types of information relating to the entity indicated by the key term, such as values from a database, statistics, visualizations, links to further information, quantitative or qualitative ratings related to the entity, and so on.

The information card 320 also includes a chatbot interface 322. The chatbot interface 322 includes a text input field 324 to receive user prompts, an expansion control 326 to expand the chatbot interface 322 to occupy more or all of the area of the information card 320, and a control 328 to initiate the presentation of suggested queries to the chatbot.

In some implementations, to allow the client device to obtain the data for the information card, the server system (1) maps an identified key term indicated by the client device to a specific entity, (2) selects an information card template corresponding to the specific entity or a type or classification of that entity, and (3) retrieves information from a database relating to the specific entity, according to the types of information specified by the selected information card template. The server system can then send the data for the information card to the client device for display. In some implementations, this process is done in substantially real time. For example, the server system can be tuned and can cache information about various entities so that the client device can obtain and display an information card less than a threshold amount of time after detecting the user interaction (e.g., 3 seconds, 1 second, 0.5 seconds, etc.).

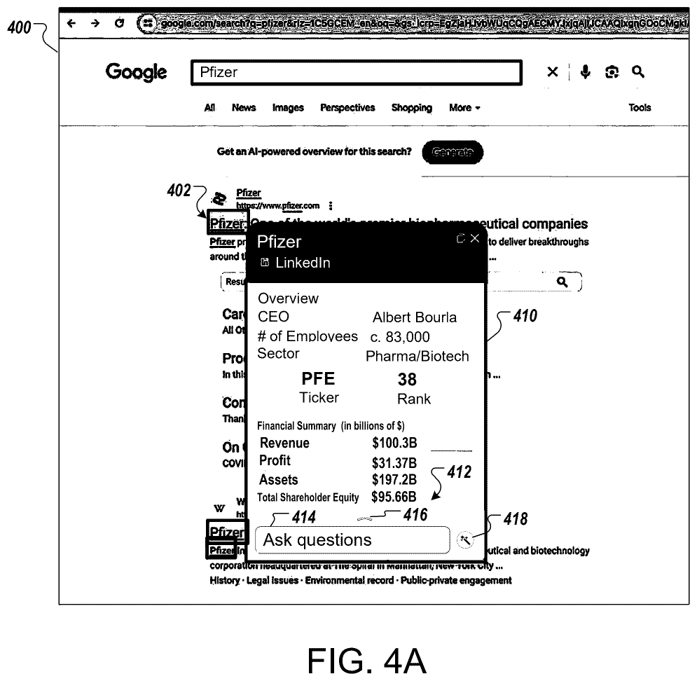

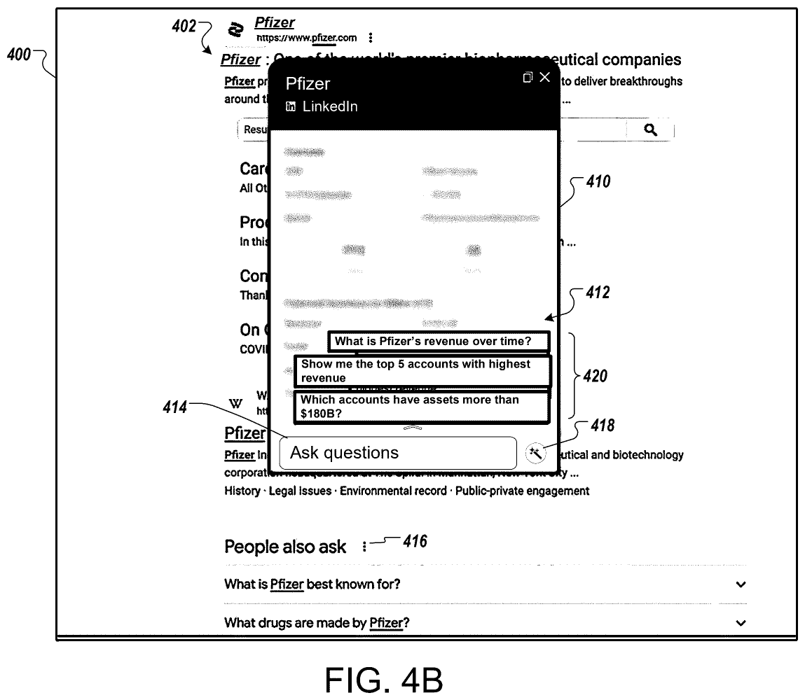

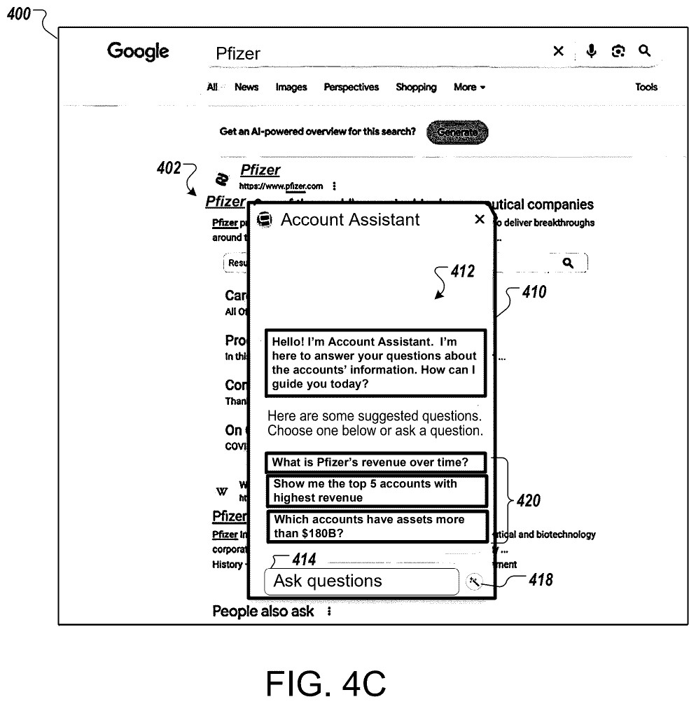

FIGS. 4A-4C show examples of user interfaces that display functionality of information cards and user interactions with information cards.

FIG. 4A shows a user interface 400 of a web browser showing a Internet search engine results page. In the example, the term “Pfizer” is a keyword that is associated in the records of the computer system 110 with an information card definition. As a result, when this term is detected in the user interface 400, the user device annotates instances of the term Pfizer and makes them interactive to trigger display of the corresponding information card. In addition, the computer system 110 sends information card data for an information card 410 about the company Pfizer. The information card 410 can include information taken from a private data set of a company (e.g., records about a company's relationship with Pfizer as a customer or a supplier).

The information card 410 also includes a chatbot interface 412, including a text input field 414, an expansion control 416, and a suggestions control 418. In this example, based on the card definition used for the Pfizer entity, the chatbot interface 412 provides interactions with a chatbot called “Account Assistant.” This chatbot is configured to provide responses about data in the same account data set used to provide information in the information card 410. As a result, the chatbot interface 412 allows the user to ask questions that involve further detail or more fine grained information about what is shown in the information card 410, or also ask about other information in the account data set more generally. In the example, the user taps or clicks on the suggestions control 418, which leads to the view shown in FIG. 4B.

In FIG. 4B, the same user interface 400 with the same web page as FIG. 1A is shown, along with the same information card 410. In response to the user interacting with the suggestions control 418, the presentation of the information card 410 is changed to provide several suggested prompts 420. These suggested prompts 420 can call for information about the Pfizer company, which is the subject of the information card 410. The suggested prompts 420 can more generally request information from the accounts data set, such as to show the user the top five accounts with the highest revenue, or to ask which accounts have assets more than threshold amount. Each of the suggested prompts 420 is interactive and selectable by a user to cause the selected prompt to either be entered in the text input field 414 or to be directly asked to the chatbot to cause a response to be provided.

In the example, the indicator values have been shaded or blurred to suggested queries 420 and the chatbot interface 412. The suggested queries 420 have been overlaid onto the indicator values. In this manner, the expanding content from the chatbot interface 412 is maintained within the boundaries or perimeter of the information card 410.

FIG. 4C shows an example view of the information card after the user has interacted with the expansion control 416 of FIG. 4A. In response to the selection of the expansion control 416, the entire information card is filled or replaced with an expanded chatbot interface 412. In this case, the entirety of the information card 410 is replaced with an interface for the account assistant chatbot.

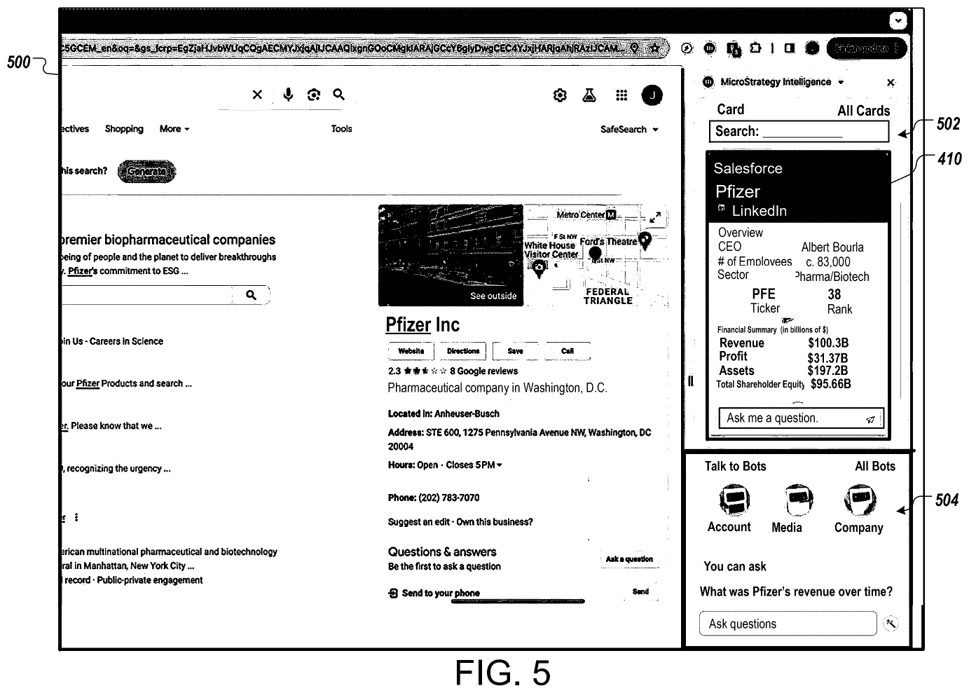

FIG. 5 shows another example user interface 500, which can be a search engine results page in a web browser just as shown for the user interface 400. This example shows how a sidebar or other region can show relevant information cards as well as provide a chatbot interface.

For example, the user interface 500 includes a sidebar on the right side that includes a card region 502 and a chatbot region 504. The card region 502 provides controls for a user to view any or all of the information cards that have been identified as relevant to the user interface 500. For example, this includes the information card 410, and potentially other information cards related to other keywords identified in the web page. The card region 502 includes a search control allowing a user to search with text keywords among the entities and the card content for the set of information cards relevant to the user interface 500. In addition, the card region 502 can include controls to allow a user to cycle through or flip through the various information cards. And some implementations, the card area 502 can allow a user to save or pin cards for future reference, where they may be accessed by the user even if they're not currently active due to the presence of a corresponding keyword in the user interface.

The chatbot region 504 provides an interface for a user to initiate conversations with one or more chatbots. In the example, there are three different chatbots, each having different characteristics for data sets they can access. The user can select a specific one of these chatbots to ask questions. In some implementations, the set of chatbots presented as options can be determined based on the access permissions of the user, so that the presented chatbot options are the set of chatbots the user is authorized to use. In some implementations, the set of chatbot options is determined based on the data sets for the information cards relevant to the web page. For example, the computer system 110 can evaluate the set of information cards generated for the current user interface 500, and then identify which chatbots are associated with at least one of the information cards or the data sets used to populate information in those information cards.

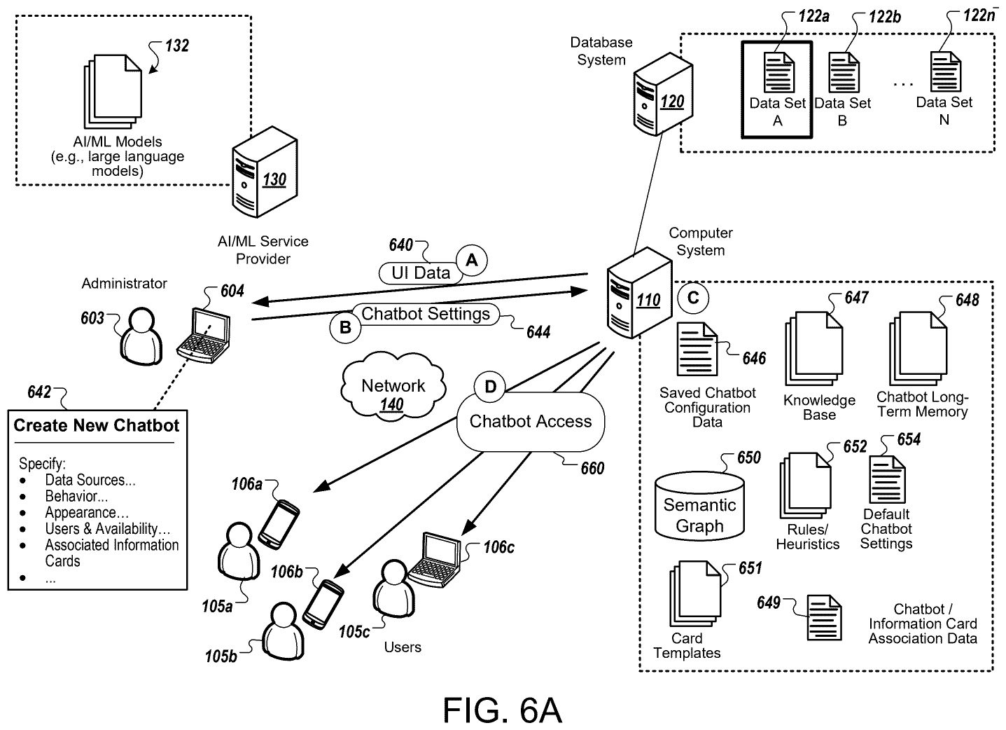

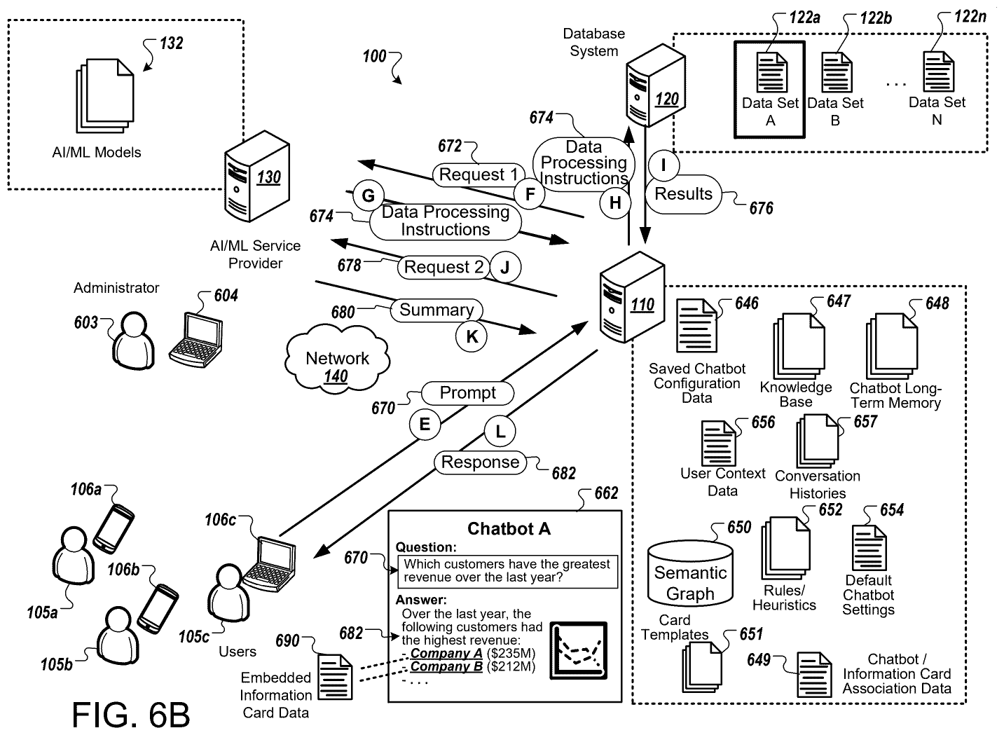

FIGS. 6A-6B are diagrams showing an example of the system 100 being used for creating, distributing, and using interactive applications such as customized chatbots. The customized chatbots can be invoked or communicated with through the chat bot interface of a information card or through other interfaces, including standalone interfaces or interfaces embedded in web pages, web applications, and so on. The system 100 includes a computer system 110, a database system 120, and a AI/ML service provider 130. The elements of the system 100 communicate over a network 140, such as the Internet. The computer system 110 coordinates a variety of functions for creating and operating chatbots. For example, the computer system 110 interacts with a client device 604 of an administrator 603 to receive customization data that indicates customizations for a chatbot. The computer system 110 then provides access to the customized chatbot to client devices 106a-106c of other users 105a-105c, and the computer system 110 coordinates processing to generate and provide answers to questions and other user prompts provided to the customized chatbot.

The example of FIGS. 6A-6B includes stages (A) to (L), which represent various operations and a flow of data, and which can occur in the order illustrated or in a different order. In FIG. 6A, stages (A) to (D) show an example of creation of a customized chatbot and access being provided to users. In FIG. 6B, stages (E) to (L) show an example of the customized chatbot being used, from issuance of a question or prompt 670 from a user to display of a response 682 from the customized chatbot.

As discussed above, the computer system 110 can be implemented using one or more servers, including one or more cloud computing systems. For example, the computer system 110 can be an application server. The computer system 110 provides front-end functionality to interface with various client devices. For example, the computer system 110 can provide an interface for creating and editing chatbots and other interactive applications that leverage AI/ML models. The interface can be an application programming interface (API), a user interface (e.g., by providing user interface data for a web page or web application), or another type of interface. As discussed further below, the computer system 110 performs various other functions to generate and save customized chatbots, to manage and grant access to existing chatbots, and to coordinate the processing of user prompts to generate responses from the chatbots.

The database system 120 can provide various data retrieval and processing functions. For example, the database system 120 can be a database management system (DBMS), and can include the capability to process operations specified in structured query language (SQL), Python code, or in other forms. The database system 120 has access to various datasets 122a-122n, which can be private datasets for organization, such as a company. The database system 120 can store and use datasets in any of various forms such as tables, data cubes, or other forms.

The AI/ML service provider 130 can be a server system or cloud computing platform that provides access to one or more AI/ML models 132, such as LLMs. The computer system 110, the database system 120, and the AI/ML service provider 130 may be implemented as separate systems or may be integrated in a single system. For example, the AI/ML service provider 130 can be a third-party service or can be managed and operated by the same party as the computer system 110 and/or the database system 120.

As an overview, to create a customized chatbot, the administrator 603 interacts with the computer system 110 to specify the features and behavior that are desired for the chatbot. Through a series interactions, the administrator 603 can specify characteristics such as which dataset(s) 122a-122n the chatbot will use to generate responses, the appearance and style of the chatbot interface, whether the chatbot can access data from the Internet or other sources, access control settings, and so on. The computer system 110 saves the settings specified by the administrator 603 and creates a new chatbot

The computer system 110 can include a variety of information that facilitates the integration of information cards and chatbot interfaces. For example, the computer system 110 can store mapping data 649 that associates chatbots with information cards. In some implementations, a card definition or card template specifies a specific chatbot to be used in the chatbot interface portion of information cards created based on that card definition or card template. For example, a card template for the company entity type can specify a particular chatbot to be used for all information cards generated using the company entity card template. The computer system can store a variety of card templates 651. In some implementations, one or more card definitions or card templates are associated with a chatbot, so that information cards of those types become embedded in or accessible through chatbot responses from that chatbot. The computer system 110 can store the information specifying the entity types or card templates for embedding in chatbot content in the chatbot configuration data 646 for the chatbot.

In stage (A), the computer system 110 provides user interface data 640 to the client device 604 over the network 140. For example, the computer system 110 can provide content of a web page or web application for creating or editing the customized chatbot. The user interface data 640 is rendered on the display of the client device 604, represented by user interface 642.

The user interface 642 provides controls to specify many different properties of the chatbot. For example, the user interface 642 enables the administrator 603 to specify the data source or dataset that the chatbot will draw from to provide responses. The user interface 642 also allows the administrator 603 to specify various aspects of the behavior of the chatbot, including suggestions, instructions to the user, and more. The user interface 642 also includes controls for the administrator 603 to specify characteristics of the appearance of the chatbot, including color schemes, layout, formatting, size, and other characteristics. The user interface 642 also includes controls for the administrator 603 to specify access control, such as to specify which users can access the chatbot, the number or frequency of questions users are permitted issue to the chatbot, the platforms or interfaces in which the chatbot is available, and so on.

In stage (B), the administrator 603 uses the interface 642 to enter the settings that customize the appearance and operation of the chatbot. The client device 604 sends the specified settings 644 to the computer system 110 over the network 140.

As an example, the administrator 603 selects a particular dataset 122a as the data source for the chatbot, as a result, the chatbot will generate responses based on the information in this dataset 122a. In some implementations, each chatbot is focused on a specific dataset or collection of records. This can allow the chatbot to be tailored closely to a specific application, task, purpose, or set of users or roles in an organization. In addition, limiting the scope of data that the chatbot can access can improve accuracy in responses by limiting the amount of extraneous information that might otherwise be introduced. In addition, focusing a chatbot on a specific dataset can increase performance and reduce response times, by reducing the complexity and amount of data that needs to be processed to generate answers.

The process of specifying the settings for the chatbot can be iterative, with potentially multiple rounds of the administrator 603 interacting with the user interface 642 to incrementally adjust and test the settings of the chatbot. For example, as discussed below for FIG. 6A, the user interface 642 can provide a preview area or test panel in which the chatbot can run and provide interactions with the administrator 603 during the process of specifying the customized chatbot settings 644. As the administrator 603 makes changes to the chatbot settings, the administrator 603 can issue questions to the chatbot and evaluate the responses and interaction behavior with the newly updated settings, allowing the administrator 603 to make further changes based on the results experienced.

Referring still to FIG. 6A, in stage (C), the computer system 110 uses the customized chatbot settings 644 from the administrator 603 to generate and save the data and settings that define the chatbot. In the example, this is shown as saved chatbot configuration data 646. For example, the computer system 110 can create a record or series of records representing the new chatbot and its customized settings. For each chatbot, the computer system 110 saves a separate set of records or definitions that specify the characteristics and customizations of that chatbot. For example, each chatbot can have a set of saved chatbot configuration data 646 that specifies, among other items, the name of the chatbot, the dataset for the chatbot, a selection of which AI/ML models 132 to use for the chatbot, the appearance and formatting characteristics of the chatbot, access control information for the chatbot, customized instructions to append to or include in user prompts to AI/ML models, and so on.

The computer system 110 can include a number of modules and datasets that facilitate the generation of new chatbots. For example, the computer system 110 can include a set of default chatbot settings 654 that provides a default or base configuration for new chatbots. The customizations specified in the received chatbot settings 644 can override or replace settings in the default set of chatbot settings 654 to form the final set of saved chatbot configuration data 646.

Generating and saving the chatbot can include registering the chatbot with a number of different applications, web pages, web applications, or other services. For example, the computer system 110 can register the new chatbot, with its name, capabilities, and applicable context, so that the option for the chatbot appears for users who have been granted access. For example, the chatbot can be made available through the document libraries of users who are approved to access the chatbot.

In some implementations, the computer system 110 enables the administrator 603 to attach one or more additional data sets to adjust the operation and output of the chatbot. For example, an additional data set can be a knowledge base 647 or data dictionary can be added. Unlike the primary data set that the user selects for the chatbot (e.g., data set 122a), the chatbot is not configured to answer questions about the additional data set or to retrieve metrics or to provide visualizations of the knowledge base 647. Instead, the knowledge base 647 can be provided to assist the chatbot in interpreting user queries and providing responses with the terminology for the user's organization. In general, the knowledge base 647 can function to provide contextual knowledge to the AI/ML models 132, so the models can classify and use the nomenclature of the end user when generating answers to user prompts.

Many different organizations or departments use terms that have a special contextual meaning, or are not part of general language, and so would not be available for training of an LLM. For example, a company may internally use various names for its products, projects, teams, locations, policies, initiatives, organizational structure, and so on. For example, a company be developing a product with a codename of “starfish” that being developed by a group of employees called “red team.” The training state of an LLM would not incorporate information about these entities, which are specific to the company and not referenced in public documents. To enable the chatbot to process questions about these internal entities and provide answers that reference them, a knowledge base 647 is designated for the chatbot to describe these and other internal terms. Each time the user submits a prompt, the knowledge base 647 can be provided to assist the LLM with the context that is appropriate for the company. The knowledge base 647 can provide information similar to a semantic graph, by describing entities and their relationships. In some cases, the information in the knowledge base 647 can be derived from a semantic graph 650 and then converted into text (e.g., unstructured, semi-structured, or structured) in a format that can be processed by the LLM.

In general, the knowledge base 647 or other additional data set can include data that maps terms or phrases to their meanings. In many cases, this can include semi-structured data or explanatory content, as a way to explain entities and relationships wo the AI/ML models 132. Although the knowledge base 647 may include definitions, more generally the information may include descriptions of people, roles, business units, products, and other terms that may be referenced. The administrator 603 may upload one or more of additional data sets and specify which additional data sets, if any, should be used to provided context for a chatbot. The data sets selected for this contextual function can then be used to provide context for all prompts and responses of the chatbot.

In some implementations, the contextual data sets or knowledge bases can be applied so that they apply to multiple chatbots. For example, an enterprise can designate one or more knowledge bases 647 as contextual data sets that can be applied consistently across the enterprise, for all chatbots created and used in the enterprise. Similarly, different departments within the enterprise may add their own particular contextual data sets that may supplement the enterprise-wide knowledge bases 647. In addition, specific contextual data sets can be added for specific chatbots. In this way, chatbots at different levels of an organization can inherit a consistent set of terminology and knowledge in an organization, which also makes maintaining the overall knowledge base much more simple. The knowledge bases 647 can additionally or alternatively be specified with a scope that corresponds to a computing environment, so that chatbots associated with a particular domain or server inherit the knowledge bases for that domain or server.

One of the advantages of the knowledge base 647 is consistency for many users and even for many different chatbots of an organization. The user submitting a prompt does not need to take any action to select or include the knowledge base 647 in the chatbot's processing, the chatbot automatically include the knowledge base 647 in its context for each prompt or question received. Also, because the knowledge base 647 can be shared or inherited by many chatbots within an organization, updating and maintaining the knowledge base 647 is simple. An edit to the knowledge base 647 is automatically applied to all of the chatbots associated with the organization, even if the chatbots were created by different administrators or provided to different sets of users.

In addition, the knowledge base 647 provides persistent context that is not lost from one prompt to another or from one session to another. The knowledge base content can also be implemented applied in a manner that the knowledge base 647 does not count toward the instruction token limits that the AI/ML models 132 consume for each response. Rather than counting toward the tokens for prompts and recent history, the knowledge base 647 can be accessed or provided to the AI/ML models 132 as a separate source of knowledge apart from the prompt and context, and so does not count toward the token limits of an LLM. Implementations of access to the knowledge base 647 can vary. For example, when a session with the chatbot is instantiated, the knowledge base can be provided as part of initializing the chatbot. In some cases, the AI/ML models 132 are additionally or alternatively configured to access the primary dataset and if the user prompt includes a term or makes a request for an item not specified in the primary dataset, the chatbot is configured for the AI/ML models 132 to then check the knowledge base or other contextual data sets. In some implementations, the knowledge base 647 can be prepared as an embedding, a vector database, or other format that can be accessed by or referred to by the AI/ML models 132.

With the additional knowledge chatbot has three general sources of information before even receiving the user prompt. First, the chatbot has the primary dataset (e.g., data set A 122a) selected by the administrator 603, which is the primary source of answer for the chatbot. Second, the chatbot has a set of instructions that the administrator 603 provided, e.g., general instructions such as the description of the primary dataset, the purpose of the chatbot, the type of user or type of task interacting with the chatbot, and a description of how the chatbot should form responses (e.g., response format, types of data to include, order of elements to include, etc.). Third, the chatbot has the knowledge base, which provides additional context behind the purpose of the bot and how the customer defines things. These types of information form a base level of information that is available for all users that use the chatbot. Also, for each user, the chatbot receives the user's prompt and also receives information about the conversation history of the user (e.g., previous queries and responses, from the current session and/or prior sessions).

In some implementations, the chatbot is designed to have a long-term memory 648, which can store information learned from users in past interactions. For example, LLMs and other AI/ML models 132, on their own, are generally stateless and do not natively understand the user context or history of interactions with the user, especially from previous sessions. The computer system 110 can facilitate learning by the chatbot to provide infrastructure that creates a long-term memory 648 for the chatbot. For example, the long-term memory 648 can store items such as definitions of terms for a particular user context, unique text elements the chatbot might encounter, and feedback from prior user interactions.

One valuable aspect of the long-term memory 648 is the ability for the chatbot to learn and adapt from explicit or implicit user feedback over time. If a user asks questions, then gives feedback they were expecting something different (e.g., either through text of a prompt to the chatbot or through an external survey or rating), then the computer system 110 can capture that feedback and update the chatbot to better provide what the user intended in the future. For example, the computer system 110 may add or adjust the instructions to the chatbot to reflect the user expectations or preferences. In some cases, this may include changing the default response format or response instructions, or may include adding rules or explanations that are context-dependent (e.g., apply to specific phrases or prompt types). This learning may occur at different levels. For example, it may include learning that particular terms, phrases, or combinations of terms call for a particular type of response. As another example, the feedback may more shift answers generally in certain ways, e.g., to be more verbose, more concise, to add or change visualizations, to change the order of content, to add or adjust summary elements, and so on.

The learning of the chatbot is managed by the computer system 110 and happens on an ongoing basis as users interact with the chatbot. The information learned is stored outside the LLM or other AI/ML models 132, and is stored in the long-term memory 648 designated for the chatbot. Each chatbot that is created can have its own long-term memory 648, which is updated by the interactions of its own users. Before the computer system 110 asks the stateless LLM to provide a response to a user prompt, the computer system 110 facilitates retrieval of data from the long-term memory 648, potentially to provide customized instructions or additional contextual data to accompany the user prompt and tailor the response based on what has been learned from prior interactions. The long-term memory 648 thus provides better reference data for LLM to use in guiding answer generation.

The long-term memory 648 can include business definitions of other users have specified or uploaded. In this way, the long-term memory 648 can supplement or expand on the descriptions provided in the knowledge base 647. The chatbots can be configured to learn at different levels, e.g., at the level of individual users, at the level of a department or group of users, and for an enterprise as a whole. In other words, the preferences of an individual may be learned and applied for that individual. In addition, the aggregate preferences learned for many individuals can be combined to also adjust the chatbot, to accelerate the adaptation of the chatbot to meet the needs of the user base. In some implementations, the computer system 110 can use access control lists and permissions for users to apply security policies to adjust access and appropriately set the context for each user.

In stage (D), the computer system 110 provides access to the chatbot to various users. 105a-105c. For example, the chatbot settings 644 specified by the administrator 603 can specify access control parameters that indicate groups of users or individual users or categories of users who receive access to the new chatbot. The computer system 110 provides access to the chatbot to authorized users in any of various ways. For example, the computer system 110 can send a message to authorize users with a URL or other link to web page, web application, or native application functionality providing the chatbot interface. As another example, the computer system 110 can update and interface such as a document library, dashboard, or other user interface to include a panel with the chatbot interface, or to include an icon, button, or other control that is interactive so that users can interact to request that the chatbot interface be provided.

Referring to FIG. 6B, after the chatbot has been customized and saved, a user 105c interacts with the chatbot. For example, the user 105c accesses a user interface 662 for the chatbot. The user interface 662 includes a field in which the user can enter a question or other user prompt 670. In the example, the user 105c enters the prompt 670, and the user's client device 106c sends the prompt 670 to the computer system 110 for processing. The computer system 110 receives the prompt 670 and begins a series of interactions used to generate the response to the prompt 670.

As discussed above, the chatbot has an associated knowledge base 647 that can include, for example, descriptions of terms that may have a unique meaning in the particular context of the user. The knowledge base 647 may be shared by multiple chatbots or even all chatbots associated with the company or organization of the user. When the computer system 110 establishes a new session of the chatbot and a user, the computer system 110 can provide the knowledge base 647 as part of initializing the session with the AI/ML model 132. As a result, the knowledge base 647 can provide additional context for all of the subsequent interactions with the AI/ML model 132.

In addition, the chatbot has information in its long-term memory 648 that has been learned through previous interactions with users. This information can be provided upon initialization of the chatbot, as the knowledge base 647 is, or can be provided in other ways. For example, the information from the long-term memory 648 can be selectively and contextually applied, as the computer system 110 analyzes the prompt 670 and determines whether there is information in the long-term memory 648 that is relevant to the content of the prompt 670. The retrieved content of the long-term memory 648 that the computer-system 648 determined to be relevant to the prompt, can then be provided with the prompt 670. As another example, certain information in the long-term memory 648 may be applicable to a specific user, role, or permission level, and the computer system 110 can provide that information in response to determining that the user 105c submitting the prompt 670 is that user or has that role or permission level. In other cases, the information in the long-term memory 648 supplements or alters the general instructions or initialization commands for starting the chatbot session, either in all cases or selectively when specific prompt content or user context is detected.

In stage (F), the computer system 110 generates and sends a first request 672 to the AI/ML service provider 130. The first request 672 includes the prompt 670 and information about the dataset 122a, and represents a request for an AI/ML model 132 to generate instructions for answering the prompt 670. For example, rather than asking the AI/ML model 132 for the answer to the prompt 670, the first request 672 can request a SQL statement, programming code, a list of operations, or other instructions that specify how to retrieve or calculate and answer to the prompt 670. As a simple example, the prompt to the LLM in the first request 672 may include an instruction such as “provide a SQL statement that retrieves the data needed to answer the question <<user prompt>>,” or “generate Python code that can run on <<database system>> to calculate the answer to the question <<user prompt>>.” The content of the first request 672 can be designed for the particular AI/ML model 132 and its capabilities.

As a result, the first request 672 can be a request for a SQL statement or Python code that, when interpreted or executed by another system such as the database system 120, will cause the other system to retrieve and/or generate a focused subset of data (e.g., a result data set) from the data set 122a that can be used to answer to the prompt 670 from the dataset 122a. The first request 672 can also include one or more custom instructions that the administrator 603 specified, to further orient the AI/ML model 132 to generate data processing instructions that are most applicable for the tasks, situations, purposes, or users that the chatbot is designed for. In some cases, one or more custom instructions are appended or otherwise included with the user prompt 670 in the first request 672.

Many AI/ML models 132, such as LLMs, operate in a substantially stateless manner, in which a general model 132 does not automatically include context of previous interactions or specific knowledge about the chatbot being used. In addition, the chatbots provided by the computer system 110 do not need to have a one-to-one relationship with the AI/ML models 132. For example, a single model 132 may serve as the model for many different customized chatbots that are created and hosted using the computer system 110. Creating and customizing a chatbot does not require training or updating an AI/ML model 132, and instead can define parameters of the chatbot experience that are separate from the AI/ML model 132 (e.g., LLM) itself (e.g., parameters such as the data set used, the custom instructions provided with user prompts, whether Internet data can be used, the format and preferences for answers, and so on).

In order for the AI/ML model 132 to be able to appropriately answer the first request 672 and provide data processing instructions to answer the prompt 670, the computer system 110 can include with the request 672 information about the dataset 122a and the database system 120. For example, the first request 672 can include metadata about the structure and contents of the dataset 122a, without including actual data of the dataset 122a. For example, the metadata may include a database schema, a description of the dataset structure, a description of semantic, meaning of the tables, columns, and other elements of the dataset, and so on. The request 672 may also include sample data, such as a few rows of data or fictitious computer-synthesized data that is of the same type and structure as the dataset 122a, but does not include the actual values from the dataset 122a.

For example, the first request 672 can indicate the types of data in the dataset 122a, and include a sample row or rows of data from the dataset 122a. The request 672 can also include information about the capabilities of the database system 120 and the data processing functions and manipulations that are available. For example, the request 672 can include instructions or description how to interact with the database system 120 to perform various processing functions, such as commands for sorting, filtering, joining, and otherwise manipulating data. In some cases, this information may include text of a user manual or other human-readable text describing the use of the database system 120. As another example, the request 672 can include a table of available commands for manipulating data in the database system 120, an API description for the database system 120, a list of valid interactions and their effects, or other data.

The first request 672 can be generated or adjusted based on information in the long-term memory 648 or other information about the user. For example, given the user interactions or feedback received through prompt-response cycles with the user 105c and/or other users, the long-term memory 648 may include information that can clarify what users intend when they ask a question as indicated in the prompt 670. For example, the long-term memory may specify that a visualization should be included, or that data should be ordered in a particular way. In addition, the computer system 110 also stores information about the user 105c and his current context, represented as user context data 156. This user context data 156 can indicate, for example, the identity of the user, permissions of the user, a device type of the user's device 106c, a location of the user, a role of the user, a department of the user, and so on. In addition, the computer system 110 stores conversation histories 157 of users that have previously interacted with the chatbot. As a result, information about previous prompts from the user 105c and previous responses, in whole or in part (e.g., in summary form) and from the current session and/or previous sessions, can be retrieved and used to supplement the prompt 670. The computer system 110 can provide the user context data 156 and conversation history 157 for the user 105c in or with the request 672, so the AI/ML model 132 can generate data processing instructions with the context of the user's situation and previous conversations, which may better explain or help disambiguate the most recent prompt 670.

In stage (G), the AI/ML service provider 130 uses the AI/ML models 132 to generate a response to the first request 672. The AI/ML service provider 130 then sends the response, a set of data processing instructions 674, to the computer system 110. As discussed above, the first request 672 requests instructions specifying the processing operations that the database system 120 can use to retrieve and/or generate (e.g., calculate) from the dataset 122 the result data that would be needed to answer the user prompt 670. As a result, the AI/ML service provider 130 uses the AI/ML models 132 to generate the data processing instructions 674 that, when executed by the database system 120, will retrieve and/or generate the data needed to answer the prompt 670. In this process, the system 100 leverages the ability of the AI/ML models 132, e.g., LLMs, to generate a set or sequence of instructions or operations. The data processing instructions 674 can be expressed in any of a variety of ways, such as one or more SQL statements, as executable or interpretable code, such as Python code, as a list of API calls or commands to be executed, and so on.

In stage (H), the computer system 110 uses the received data processing instructions 674 to instruct the database system 120 to obtain (e.g., retrieve, calculate, generate, etc.) the data needed to answer the user prompt 670. For example, the computer system 110 may send a request that includes the data processing instructions 674 to the database system 120, in order to request the needed data. In some implementations, the computer system 110 may apply a set of rules or validation checks to verify that the data processing instructions 674 are valid and appropriate to be executed by the database system 120. For example, the computer system 110 can store rules or heuristics 652 that can evaluate the data processing instructions 674 element by element and/or as a whole to verify and correct the data processing instructions 674 if needed before they are sent to the database system 120. In some implementations, the computer system 110 uses the rules or heuristics 652 to convert or transform the data processing instructions 674 from one format or type to another.

When interacting with the AI/ML service provider 130 and/or the database system 120, the computer system 110 can apply the customized settings and properties that the administrator 603 defined for the chatbot. For example, the administrator 603 can limit which portions of the dataset 122a can be accessed by the chatbot, and so the computer system 110 can apply those limits so that the first request 672 to the AI/ML service provider 130 does not reference omitted data (e.g., excluding from the description of the data set 122a columns or tables that are not to be referenced, so the AI/ML models 132 cannot use them or even determine that they exist). Similarly the first request 672 can include instructions to specifically exclude or avoid using certain data. In addition, or as an alternative, the computer system 110 can filter, edit, or otherwise check the data processing instructions 674 so that the operations specified do not draw from or become calculated based on excluded data. In addition, or as an alternative, the computer system 110 can analyze the results 676 to verify that the results 676 do not include or are not based on the excluded data.

As another example, the computer system 110 can apply access control policies or custom behavior based on the identity or role of the user 105c issuing the prompt 670. Those custom behaviors can be reflected in the interactions of the computer system 110 to the AI/ML service provider 130, such as in the request 672, as well as in the interactions with the database system 120.

In stage (I), the database system 120 generates and sends results 676 that include the data retrieved from and/or generated based on applying the data processing instructions 674 for the dataset 122a. The database system 120 processes or executes the data processing instructions 674 that it receives, which creates the results 676, which may be in any of various forms, such as records retrieved, data series, aggregations of data, statistics about data in the dataset 122a, subsets of the dataset 122a determined to be relevant, and so on.

In the illustrated example, the user prompt 670 asks which customers have the greatest revenue over the last year. The data processing instructions 674 generated by the AI/ML models 132 specify the operations needed to generate measures of revenue by region for the previous year. For example, the data processing instructions 674 may include a SQL statement to retrieve these values, or may include a set of instructions in a programming language, such as Python. The results 676 generated by the database system 120 include the values needed to answer the question in the user prompt 670. In other words, the results 676 include values of revenue for the customers specified in the dataset 122a, appropriately labeled or associated with identifiers for those customers. In this process, the AI/ML models 132 have been leveraged to obtain the results 676, however, the AI/ML models 132 did not need or receive access to the dataset 122a itself, and the AI/ML models 132 did not incur the resource costs of having to process the dataset 122a. In addition, the database system 120 and its reliable, repeatable calculations ensure that the results 676 are accurate, without the AI/ML models 132 introducing uncertainty into the calculations.

In addition, the dataset 122a may be very large, much larger than the maximum context length of an LLM used for the AI/ML model 132. In many cases, the amount of data in the dataset 122a may be orders of magnitude larger than the maximum context size that the LLM can process. The database system 120 can process a large dataset much more quickly and with greater power efficiency than an LLM can. Due to limits on LLM context sizes, it may be impractical or impossible for an LLM to analyze the dataset 122a to generate the needed results 676.

In stage (J), the computer system 110 sends a second request 678 to the AI/ML service provider 130. The second request 678 includes the results 676 and requests that the AI/ML models 132 generate a summary or other text response that answers the prompt 670 based on the results 676. For example, the second request 678 may be a request to answer the prompt 670 using the data in the results 676 as context. As another example, the second request 678 may be a request for the AI/ML models 132 to summarize the results 676, in addition to or instead of answering the user prompt 670. The second request 678 can also include one or more custom instructions that the administrator 603 specified, to further orient the AI/ML model 132 to respond in the format and with the content that is most applicable for the dataset 122a and/or the overall purpose for which the chatbot was designed (e.g., customization for a particular organization, set of users or user roles, set of tasks, etc.). In some cases, one or more custom instructions are appended or otherwise included with the user prompt 670 in the second request 678.

As with the first request 672, the computer system 110 can provide the user context data 156 and conversation history 157 for the user 105c in or with the second request 678, so the AI/ML model 132 can generate a response based on the context of the user's situation and the user's previous conversations, which may better explain or help disambiguate the most recent prompt 670. The computer system 110 can also provide information from the long-term memory 648 that the computer system 110 determines to be relevant, potentially as determined to be relevant specifically to the user 105c, the user context data 156, and/or the prompt 670.

In some implementations, the chatbot is configured to generate visualizations as part of the response to a user prompt 670. To create these visualizations, the computer system 110 can include in the second request 678, or as an additional request, a request for the AI/ML models 132 to indicate an appropriate type and format of visualization for the response to the request 678. The AI/ML models 132 can then be used to specify the parameters for the visualization, such as the type of visualization (e.g., line chart, bar chart, line graph, geographical map, heat map, etc.), and identification of which data items are shown on different axes or dimensions of the visualization, the ranges to show, the labels to use, the color scheme, and or other properties.

In stage (K), the AI/ML service provider 130 uses the AI/ML models 132 to generate a response to the user prompt 670, e.g., a summary 680 of the results 676 or other response requested by the second request 678. For example, the second request 678 may include or provide access to the results 676 and the user prompt 670, and so the AI/ML models 132 answer the prompt 670 from the context provided by the results 676. In some implementations, this may be a summary of the results 676 and/or may include values extracted from the results 676 with added text description generated by the AI/ML models 132.

For example, in the illustrated example, the AI/ML models 132 indicate the specific customers having the greatest revenue, as requested by the prompt 670, along with an indication of the revenue values taken from the results 676, along with other description and contacts. If the request 678 requests information about a visualization, or if the AI/ML models 132 determine that a visualization is likely appropriate or beneficial, then the summary 680 can include a visualization description. The visualization description can specify the properties recommended for a visualization of the results 676 as a whole, or for specific items that answer the user prompt 670.

In stage (L), the computer system 110 processes the summary 680, and generates and sends a response 682 as the answer of the chatbot to the user prompt 670. The response 682 is then displayed on the user interface 662 of the client device 106c. The computer system 110 can process the summary 680 to create the response 682, for example, by applying customized settings or policies specified in the saved chatbot configuration data 646. In this way, the computer system 110 can apply customized style, formatting, content preferences or restrictions, and other customizations that were defined by the administrator 603. In addition, or as an alternative, the computer system 110 can incorporate those customizations when making the request 678. For example, the computer system 110 may include in the request 678 preferences for a concise or verbose answer, the tone or style of text used, and other preferences.

When the computer system 110 generates the response 682, the computer system 110 can compare content of the summary 680 or other content to be provided with a set of keywords corresponding to information cards. When keywords in the set are identified, the computer system 110 can cause those keywords to become interactive and visually distinguished from other terms in the chatbot response content provided. The computer system 110 can also use the card templates 651 for the keywords identified (and their entity types) to generate and provide information card data. For example, the computer system 110 determines that at least two keywords, “Company A” and “Company B,” are present in the summary 680. As a result, the computer system 110 generates the response 682 to annotate and make interactive instances of the terms “Company A” and “Company B.” In addition, the computer system 110 generates information card data to enable display of an information card for each of the entities represented by the keywords. This includes accessing the card template 651 for the entity type of company, and for each of the companies, retrieving the appropriate indicator values from the data set 122A through communication with the database system 120. The information card data for these two information cards can be sent with or as part of the response 682 so that the information card content is effectively embedded with or transferred with the response 682. For example, this is illustrated as embedded information card data 690.

When a visualization is requested by the prompt 670 or suggested by the AI/ML models 132, the computer system 110 uses the visualization description from the AI/ML models 132 to generate the actual visualization content. In this manner, the visualization that is provided is based on reliable, accurate data or calculations in the results 676 and/or the dataset 122a. For example, the visualization that is rendered has the type of data specified by the AI/ML model 132, and in the arrangement specified by the AI/ML models 132, but with values or data series shown being determined through data retrieval and/or calculations of the database system 120 to ensure accuracy and reliability.

Through any and all of the interactions of the computer system 110 to generate and provide the response 682, the computer system 110 applies the settings and properties specified in the saved chatbot configuration data 646. As a result, the behavior and characteristics that the administrator 603 specified for the chatbot can be enforced at any or all stages of the process to provide the customized interface and chatbot behavior that the administrator 603 desired.

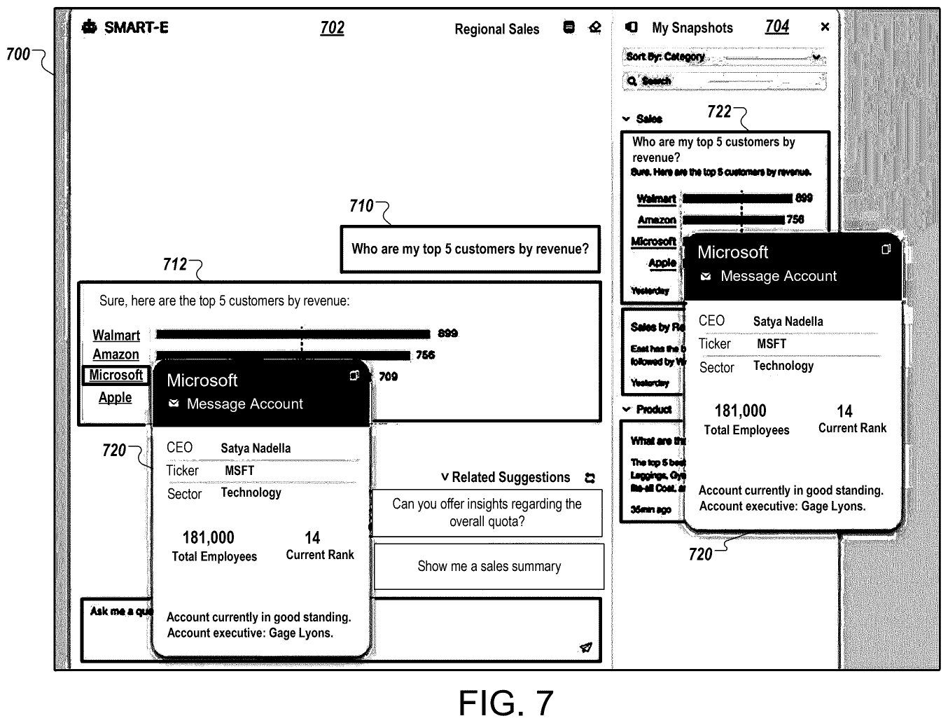

FIG. 7 shows an example of a user interface 700 of a chat bot interface from which information cards can be displayed. Any example, a chatbot interface area 702 is provided for a user to converse with a chat bot called “SMART-E.” The interface shows a user prompt 710 and a chat bot response 712. In the chatbot response, various company names have been identified as keywords for which corresponding information cards can be provided. For example, the computer system 110, when generating the content of the chatbot response 712, can determine that these terms fit the criteria for generating information cards. The computer system 110 can create the information card data allowing an information card 720 to be rendered and displayed by the user device in response to user interaction with the term, when the chatbot response 712 is presented. In this case, the term “Microsoft” has been tapped or hovered over by a user, and so the information card 720 having information about Microsoft, is presented in response.

The user interface 700 also includes a snapshot area 704 that shows chatbot responses that the user has saved for future use. The snapshot data that is stored can include the markup language content or code causing identified keywords to be interactive, as well as the corresponding information card data. For example, the user can mouse over or tap the instance of the term Microsoft in a snapshot 722 to trigger display of the information card 720, just as the user could when the content was originally presented in the chatbot response 712.

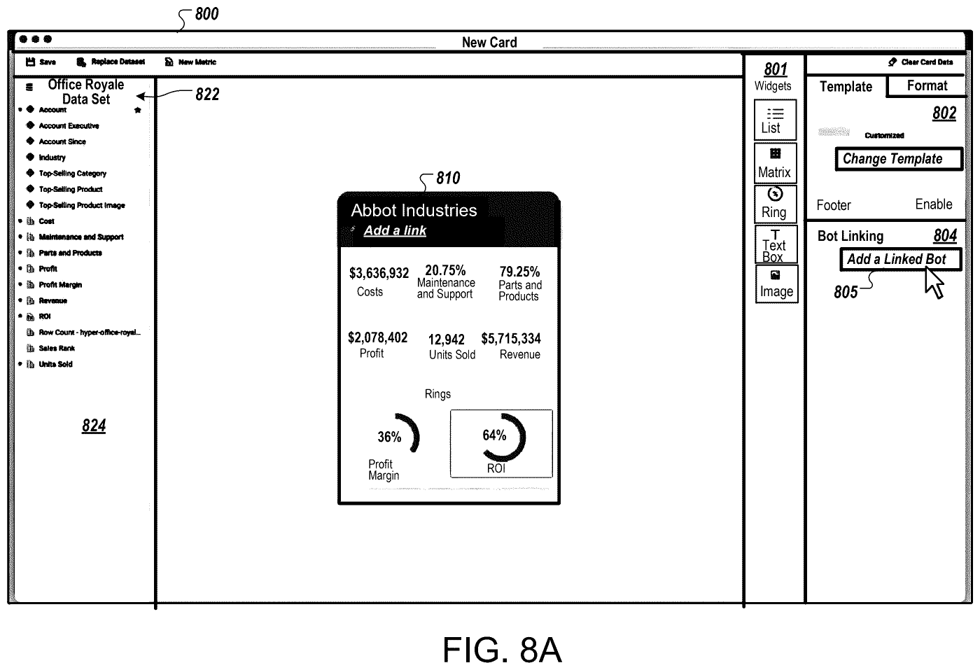

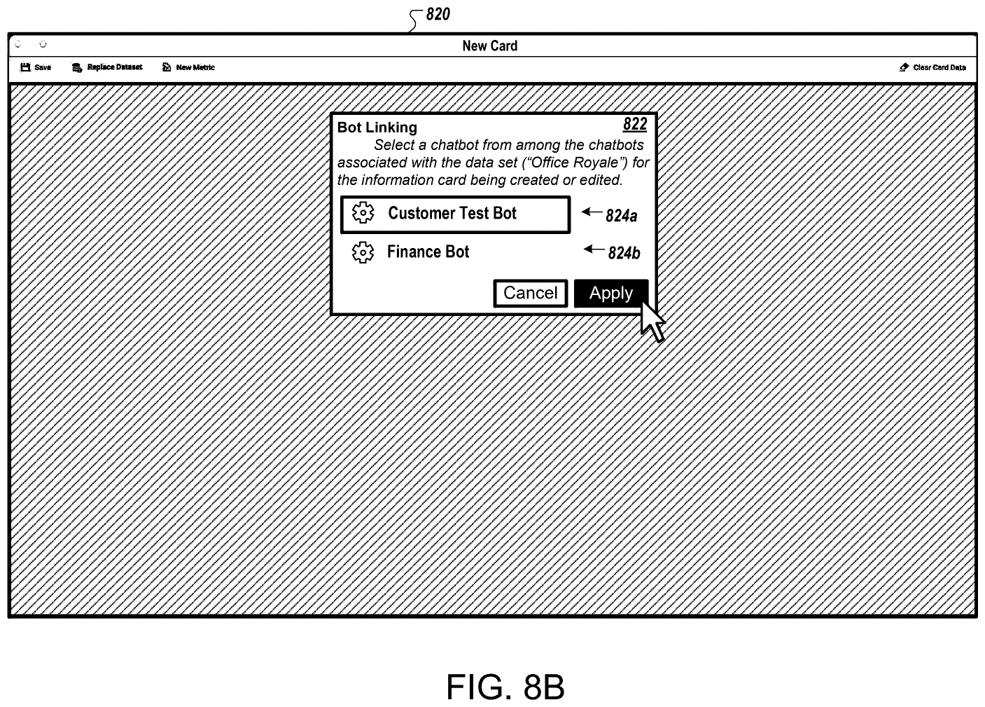

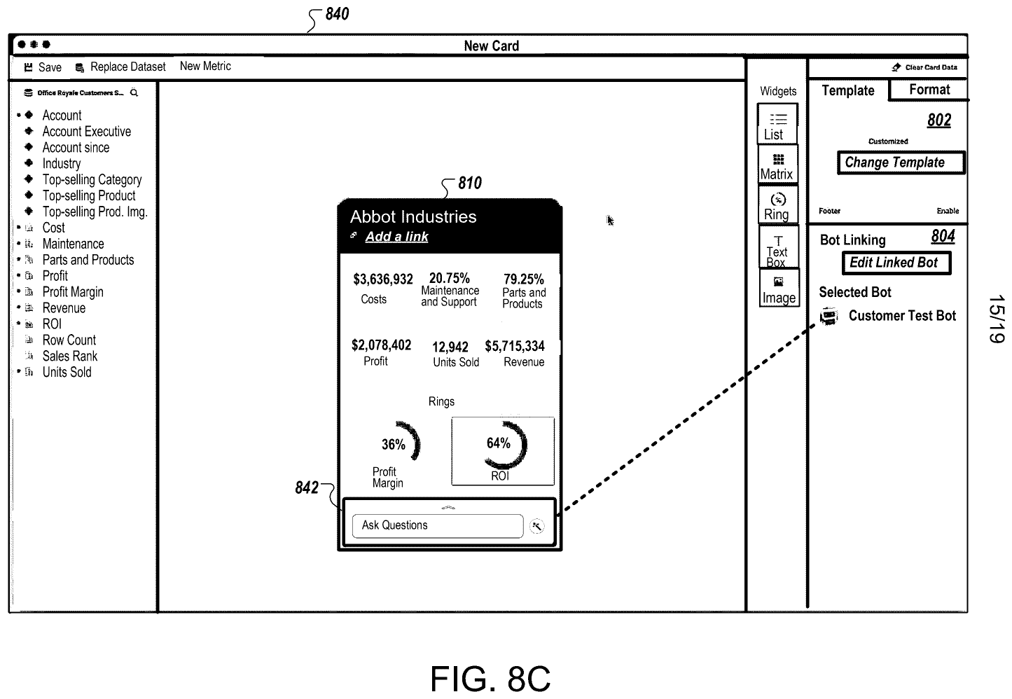

FIGS. 8A-8C show an example of user interfaces to configure linking of chatbots 2 information cards. FIG. 8A shows a user interface 800 that enables the user to create an information card definition or card template. In the example, the user is creating a card 810 that can be displayed for a company type of entity. The view of the card 810 shows preview data populated for a particular company, “Abbot Industries,” but the same layout and selections attributes and metrics shown would be used for other companies, with their names and data populated in the same way. The user interface 800 shows that a particular data set 822, “Office Royale Data Set,” is the source of information for the new card definition. Information about the data set 822 is provided in a data catalog region 824, which lists attributes present in the data set 822, including account, account executive, industry, top selling category, top selling product, and top selling product image. The data catalog region 824 also shows various metrics, including cost, maintenance and support, parts and products, profit, profit margin, revenue, and so on. These elements of the data set 822 shown in the data catalog region 824 represent types of data that can be selected or defined to be presented in information cards based on the card design being created.

On the right side of the user interface 800, various regions provide the user controls to alter the card design. For example, a widget region 801 shows various types of widgets or elements that can be dragged and dropped onto the card 810 to specify different types of visual elements, which the user can then further specify by dragging or selecting a data object from the data catalog 824 onto a widget in the card 810. In addition, a template region 802 allows a user to select from among various layout templates to change the overall look and feel of the card 810.

The user interface 800 also includes a bot linking region 804 that includes a control that allows the user to add a chatbot. For example, the bot linking region 804 allows a user to add chatbot access to the card design represented by the card 810. The user can specify which chatbot users should converse with through the card 810 as well. In the example, the user clicks a button 805 or other user interface control to initiate linking of a chatbot to the card design. This action can add chatbot interface features and regions to the card design, and can trigger presentation of additional functionality for selecting a particular chatbot to be accessed through the card.

FIG. 8B shows another user interface 820 that is presented after the user interacts with the button 805 from FIG. 8A. Once the user indicates that chatbot access should be granted through the card being designed, the computer system 110 identifies chatbots that are configured to answer questions about the same data set 822 used to populate information in the card 810 being designed. The computer system 110 also verifies or filters the set of chatbots to identify the chatbots that are available or accessible (e.g., according to security policies or access control lists). In this case, the computer system determines that two chatbots are available and use the data set 822, a customer test bot and a finance bot. In the user interface 820, these two chatbot options are presented to the user with corresponding user interface elements 824a, 824b. The user can select one of these chatbots by interacting with the corresponding user interface element 824a-824b, and then apply the selection to link that particular bot to the card being designed.

FIG. 8C shows another user interface 840 that is presented after the user selects the customer test bot to be linked to the card design represented by card 810. In response, the card 810 shown in the preview area is updated to include a chatbot interface 842, including a text box to receive these are prompts and a control to request generation of suggested prompts. The selection of the chatbot is shown in the bot linking region 804, which indicates that questions entered in the chatbot interface 842 of any cards generated based on the current card design or card template being created will be routed to the customer test bot to provide the answers.

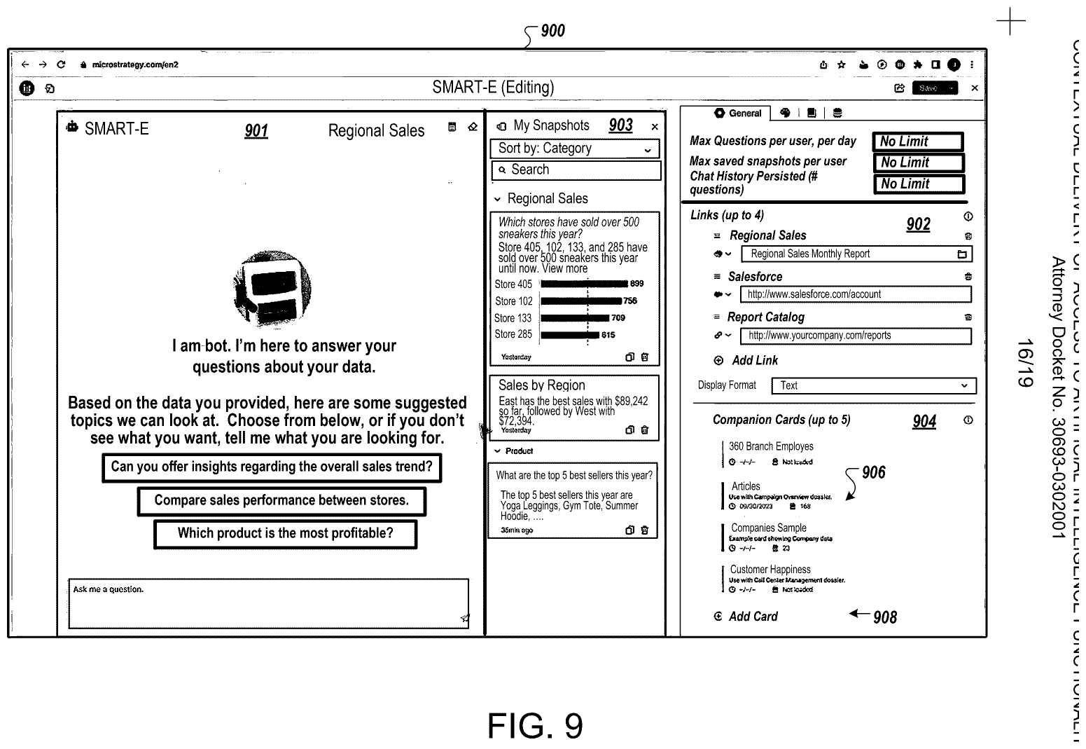

FIG. 9 shows an example of a user interface 900 that enables the user to specify information card types that can be embedded in or presented with a chatbot interface. For example, the user interface 900 represents and editing tool for editing the properties of a particular chatbot called “SMART-E.” The user interface 900 includes a preview chatbot interface region 901, showing what a user would see when interacting with a stand alone or full size view of a chatbot interface for this chatbot. The user interface 900 also includes a snapshot area 903 that presents saved answers that the user has designated to save or pin for later use.

On the right side of the user interface 900, various interactive elements are provided to alter the appearance and functionality of the chatbot and its interface. For example, the user can specify limits for the number of questions allowed to be asked per user per day, or set a limit for the maximum number of snapshots per user, or specify the length in questions of chatbot history that should persist. In addition, a link region 902 includes controls that enable the user to specify additional data sources that the chatbot can draw from when answering user prompts. For example, the chat about may be configured to use one or more datasets 122a-122n, but the administrator may specify additional data sources to be used, such as a regional sales monthly report, Salesforce data, the report catalog, and so on. In other cases, the linked resources may be presented in the chatbot interface 901 for a user to access from the chatbot interface but directly through a hyperlink or other user interface control.

The user interface 900 also includes a companion card region 904 showing a list 906 of information card definitions or card templates that the administrator has specified can be presented with chatbot content. The cards that are associated with the chatbot in this way can be cards that draw data from the same data set(s) that the chatbot “SMART-E” can answer questions about. In some implementations, the system allows the administrator to set card definitions to be used which draw information from other datasets beyond what the chatbot can use and answer about.

In the list 906, the first of the associated cards is labeled “360 Branch Employees,” which is an information card definition to provide information about employees (e.g., entities of the employee type.” As a result, when the computer system 110 is generating a chatbot response for the SMART-E chatbot, the computer system 110 compares list of employee names with the chatbot content to identify matches. When an employee name is detected in the chat box response being generated, the computer system 110 annotates it and makes it interactive to trigger a card of the “360 Branch Employees” type, having indicator values (e.g., attribute or metric values) populated based on data from the corresponding data set. The computer system 110 can also generate the information card data for the employee whose name is detected, and the computer system 110 can send the information card data with the chatbot response, so that the user device has the information card ready to present when a user taps, clicks, pauses on, or otherwise interacts with the term.

The other card types in the list 906 are designed to provide information about other types of entities, with values of different attributes or metrics as specified in the corresponding card definitions. We companion card region 904 also includes a user interface control 908, that the user can interact with to add another type of card to be shown with chatbot content in the chatbot interface. For example, when the user clicks or taps the control 908, the computer system 110 can present a pop up or overlay region with a list or menu of information cards that are available in the current environment. In some implementations, the computer system 110 can filter that list to show card types that are designed to work with the same data set(s) as the chatbot, or which at least are designed to be presented for entities of types represented in the data set(s) used by the chatbot.

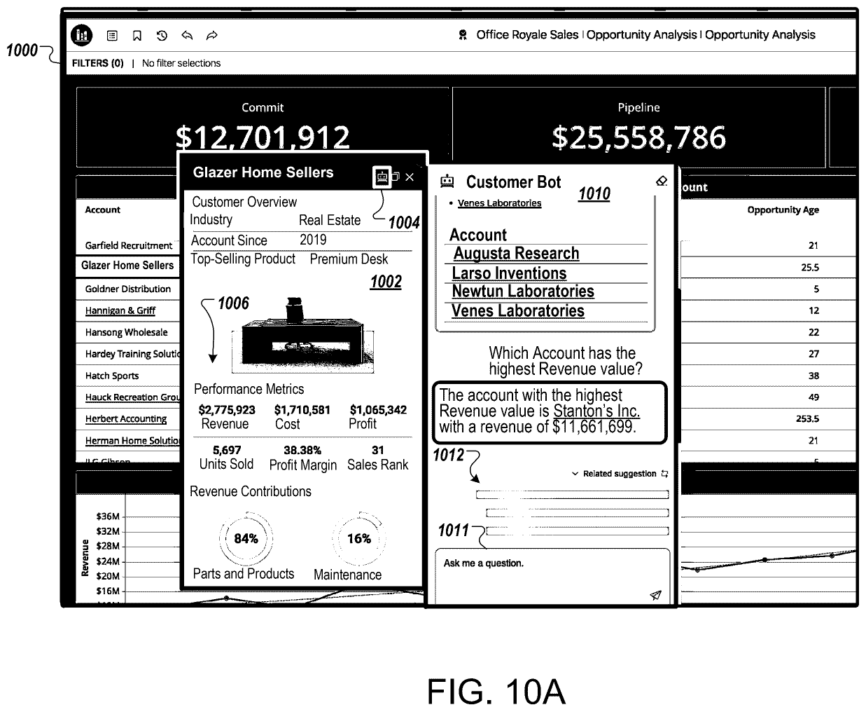

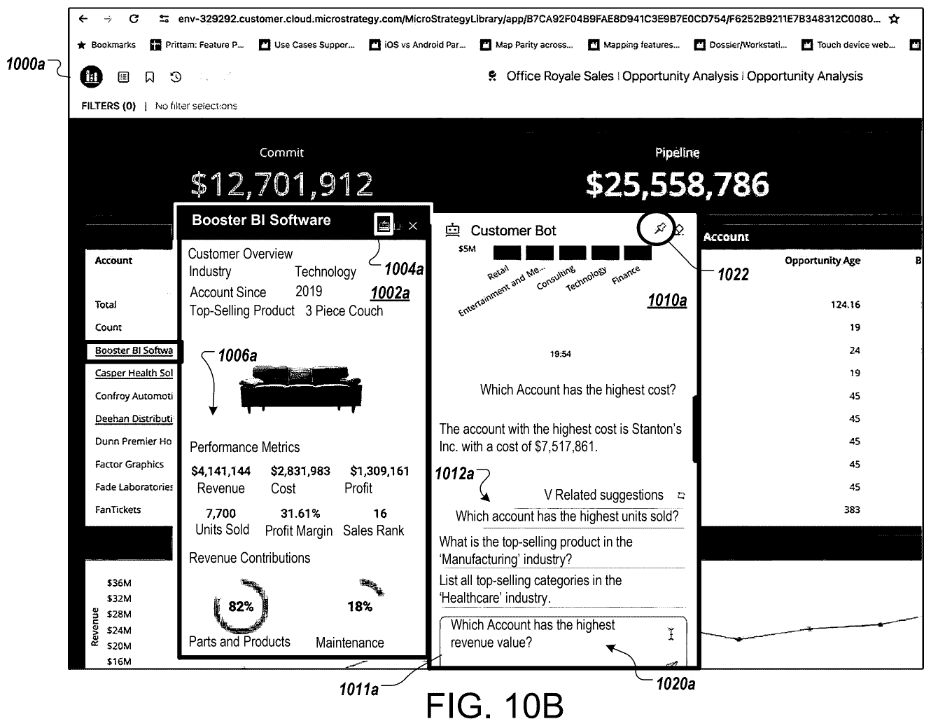

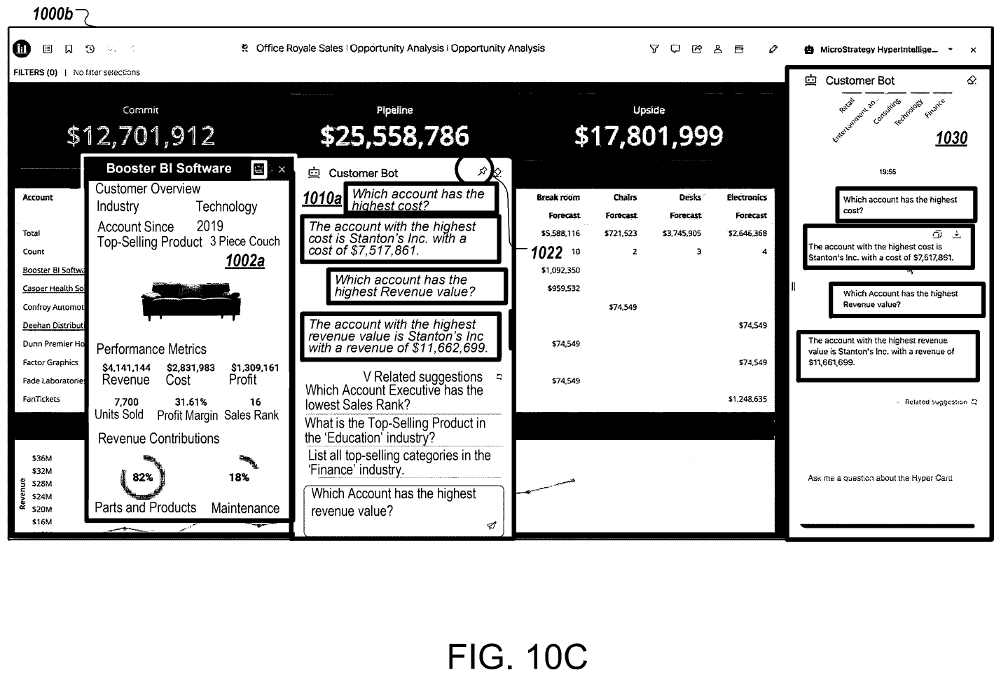

FIG. 10A shows another example of a user interface 1000 in which information cards having chatbot interfaces can be presented. In the example, the user interface 1000 shows a document being viewed by a user. A particular name 1001, “Glazer Home Sellers,” is recognized by the system 110 as the name of a customer, and the system 110 determines that there is an information card defined for entities of the customer type. When the user hovers the mouse over this instance of the name 1001, the user's device detects this and it triggers display of the information card 1002 on the user's device. The information card 1002 includes various indicator values 1006 along with labels specifying the meaning of those values. The information card 1002 also includes an icon 1004 that the user can interact with to cause another panel with the chatbot interface 1010 to be presented.

In this example, the user clicks the control 1004, which causes the chatbot interface 1010 to be displayed adjacent to the information card 1002. This provides communication with the chatbot “customer bot” that was previously designated as the chat bot that users should communicate with regarding the information card type of the information card 1002 and/or the underlying data set that the indicator values 1006 were derived from. The chat bot interface 1010 includes area for previous user prompts and chat bot answers in the conversation. The chat bot interface 1010 also includes a suggestion area 1012 where suggested prompts are displayed and an input text field 1011 where the user can enter questions for the chatbot.

FIG. 10B shows a user interface 1000a, which is similar to the user interface 1000 of FIG. 10B but shows a different information card 1002a for a different entity, “Booster BI Software,” as will as a corresponding chatbot interface 1010a. The user has interacted with the region of a particular indicator value 1006a (e.g., the value or its label), in this case, the performance metric for “revenue.” In response, the system inserts into the input text field 1011a a suggested prompt 1020a related to the metric selected by the user. The information card 1002a and the chatbot interface 1010a can thus be linked so that when a user interacts with a portion of the information card 1002a, suggested queries or prompt text related to the selected portion can be populated in the chat bot interface 1010a. The suggested queries can be automatically generated using an AI/ML model 132, or may be predefined by an administrator, such as administrator that creates or edits the information card definition.

The chatbot interface 1010a can include a pin control 1022 that enables the user to anchor the chatbot interface 1010a to a portion of the user interface 1000a other than the information card 1002a, which is presented as a temporary overlay or pop up. By selecting the pin control 1022, the user can cause the chatbot interface 1010a to persist after the information card 1002a is dismissed.

FIG. 10C shows another example user interface 1000b, which represents the interface after the user has selected the pin control 1022. This results in a sidebar 1030 being presented at the right side of the user interface, which transfers the content previously in the how about interface 1010a and causes it to persist as the user continues to scroll through the document or otherwise change the current view. Typically, the original chat bot interface 101a0 will be hidden or dismissed after the sidebar chatbot interface 1030 is presented.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

1. A method performed by one or more computers, the method comprising:
providing, by the one or more computers, data for an information card corresponding to an entity, wherein the information card includes (i) content including one or more attributes or measures for the entity and (ii) one or more elements for accessing a chatbot configured to provide responses generated using one or more artificial intelligence and/or machine learning (AI/ML) models;
after user interaction with the one or more elements provided by the information card, receiving, by the one or more computers, a user prompt from the user entered through a chatbot interface that is provided on the information card or is presented in response to the user interaction with the one or more elements; and
providing, by the one or more computers, a chatbot response to the user prompt for presentation in the chatbot interface, wherein the chatbot response is generated based on the content of the information card.

2. The method of claim 1, wherein the information card is based on a card template corresponding to an entity type, and the card template is associated with a particular chatbot from among multiple chatbots; and
wherein the one or more elements provide access to the particular chatbot.

3. The method of claim 1, wherein the one or more computers are configured to provide chatbot responses from each of multiple chatbots, wherein at least some of the multiple chatbots are configured to provide responses based on different data sets;
wherein the method includes storing multiple card templates,
wherein each card template corresponds to an entity type,
wherein the one or more computers are configured to use each card template to generate information cards for each of multiple entities of the corresponding entity type, and
wherein each of the multiple card templates specifies a chatbot, from among the multiple chatbots, to be used to respond to user prompts;
wherein the one or more computers are configured to select, in response to a user prompt associated with a particular information card, to use the chatbot that is specified in the card template used to generate the particular information card for generating a chatbot response.

4. The method of claim 1, wherein the one or more AI/ML models comprise a large language model (LLM).

5. The method of claim 4, wherein the LLM has a context window; and
wherein the method includes providing the content of the information card to the LLM so the content of the information card is included in a context window of the LLM when the LLM is used to generate the chatbot response.

6. The method of claim 1, wherein the information card is displayed at a user device in response to interaction of the user with a user interface, and wherein the chatbot response is generated based on content of the information card.

7. The method of claim 6, comprising providing the content of the user interface to the one or more AI/ML models so the content of the information card is included in a context window of the one or more AI/ML models when the one or more AI/ML models are used to generate the chatbot response.

8. The method of claim 1, wherein the one or more elements comprise a text entry field configured to receive a user prompt to the chatbot.

9. The method of claim 1, wherein the one or more elements comprise an interactive element configured to respond to user interaction to cause a chatbot interface to be provided in the information card or adjacent to the information card.

10. The method of claim 1, wherein the one or more elements are configured to cause, upon user interaction, presentation of a chatbot interface; and
wherein the one or more computers are configured to provide, for display in the chatbot interface, one or more suggested prompts that are based on the content of the information card.

11. The method of claim 10, comprising generating the suggested prompts based on data that identifies the entity, such that one or more of the suggested prompts includes a reference to the entity.

12. The method of claim 10, wherein the one or more of the suggested prompts are displayed before the user enters a prompt in the chatbot interface, and wherein at least one of the suggested prompts is generated to include a reference to the entity based on the information card corresponding to the entity.

13. A system comprising:
one or more computers; and
one or more computer-readable media storing instructions that are operable, when executed by the one or more computers, to cause the system to perform operations comprising:
providing, by the one or more computers, data for an information card corresponding to an entity, wherein the information card includes (i) content including one or more attributes or measures for the entity and (ii) one or more elements for accessing a chatbot configured to provide responses generated using one or more artificial intelligence and/or machine learning (AI/ML) models;
after user interaction with the one or more elements provided by the information card, receiving, by the one or more computers, a user prompt from the user entered through a chatbot interface that is provided on the information card or is presented in response to the user interaction with the one or more elements; and
providing, by the one or more computers, a chatbot response to the user prompt for presentation in the chatbot interface, wherein the chatbot response is generated based on the content of the information card.

14. The system of claim 13, wherein the information card is based on a card template corresponding to an entity type, and the card template is associated with a particular chatbot from among multiple chatbots;
wherein the one or more elements provide access to the particular chatbot.

15. The system of claim 13, wherein the one or more computers are configured to provide chatbot responses from each of multiple chatbots, wherein at least some of the multiple chatbots are configured to provide responses based on different data sets;
wherein the operations comprise storing multiple card templates,
wherein each card template corresponds to an entity type,
wherein the one or more computers are configured to use each card template to generate information cards for each of multiple entities of the corresponding entity type, and
wherein each of the multiple card templates specifies a chatbot, from among the multiple chatbots, to be used to respond to user prompts;
wherein the one or more computers are configured to select, in response to a user prompt associated with a particular information card, to use the chatbot that is specified in the card template used to generate the particular information card for generating a chatbot response.

16. The system of claim 13, wherein the one or more AI/ML models comprise a large language model (LLM).

17. One or more non-transitory computer-readable media storing instructions that are operable, when executed by one or more computers, to cause the one or more computers to perform operations comprising:
providing, by the one or more computers, data for an information card corresponding to an entity, wherein the information card includes (i) content including one or more attributes or measures for the entity and (ii) one or more elements for accessing a chatbot configured to provide responses generated using one or more artificial intelligence and/or machine learning (AI/ML) models;
after user interaction with the one or more elements provided by the information card, receiving, by the one or more computers, a user prompt from the user entered through a chatbot interface that is provided on the information card or is presented in response to the user interaction with the one or more elements; and
providing, by the one or more computers, a chatbot response to the user prompt for presentation in the chatbot interface, wherein the chatbot response is generated based on the content of the information card.

18. The one or more non-transitory computer-readable media of claim 17, wherein the information card is based on a card template corresponding to an entity type, and the card template is associated with a particular chatbot from among multiple chatbots;
wherein the one or more elements provide access to the particular chatbot.

19. The one or more non-transitory computer-readable media of claim 17, wherein the one or more computers are configured to provide chatbot responses from each of multiple chatbots, wherein at least some of the multiple chatbots are configured to provide responses based on different data sets;
wherein the operations comprise storing multiple card templates,
wherein each card template corresponds to an entity type,
wherein the one or more computers are configured to use each card template to generate information cards for each of multiple entities of the corresponding entity type, and
wherein each of the multiple card templates specifies a chatbot, from among the multiple chatbots, to be used to respond to user prompts;
wherein the one or more computers are configured to select, in response to a user prompt associated with a particular information card, to use the chatbot that is specified in the card template used to generate the particular information card for generating a chatbot response.

20. The one or more non-transitory computer-readable media of claim 17, wherein the one or more AI/ML models comprise a large language model (LLM).
